(19) United States
(12) Patent Application Publication
(10) Pub. No.: US 2022/0222750 A1
(43) Pub. Date: Jul. 14, 2022

(54) DATA COMMUNICATIONS PROTOCOL PLATFORM

(71) Applicant: Say Technologies LLC, Menlo Park, CA (US)

(72) Inventors: Alexander Lebow, New York, NY (US); Michael Kaufman, New York, NY (US); Patrick Vergara, New York, NY (US); Julio Fredes, New York, NY (US); Jeffrey J. Cruttenden, New York, NY (US); Austin Ash, New York, NY (US); Andy Beaudoin, New York, NY (US); Alex Ermenidis, New York, NY (US); Mary Guimbarda, New York, NY (US); Zach Hascoe, New York, NY (US); Chloe Imus, New York, NY (US); Lea Jafiarova, New York, NY (US); Zach Kauffman, Philadelphia, PA (US); Damian Mastylo, New York, NY (US); Anthony Parente, New York, NY (US); Laurent Paulhac, Waccabuc, NY (US); Joe Rosenwald, Philadelphia, PA (US); Stephen Silber, New York, NY (US); Corey Stanton, Philadelphia, PA (US); Marc Zubricky, Philadelphia, PA (US)

(21) Appl. No.: 17/528,142

(22) Filed: Nov. 16, 2021

Related U.S. Application Data
(60) Provisional application No. 63/114,437, filed on Nov. 16, 2020.
(60) Provisional application No. 63/114,403, filed on Nov. 16, 2020.

(51) Int. Cl. G06Q 40/06; G06Q 40/04; G06Q 20/32; G06Q 20/40

(52) U.S. Cl. CPC G06Q 40/06; G06Q 20/4014; G06Q 20/322; G06Q 40/04

(57) ABSTRACT

A computer program product comprising computer-readable code embodied in a non-transitory computer-readable storage medium which, when executed by one or more processors of a computing device, causes the computing device to perform a method comprising obtaining share portfolio information for one or more shareholders from a broker database, obtaining proxy voting requirements from at least one share issuer, receiving shareholder preference data from the one or more shareholders, generating proxy vote recommendations based on the share portfolio information, proxy voting requirements and the shareholder preference data, and providing the proxy vote recommendations to an interactive graphical interface of a shareholder access point using Application Programming Interface (API).

### CROSS-REFERENCE TO RELATED APPLICATIONS

This application claims priority to U.S. Patent Application Ser. No. 63/114,403, filed Nov. 16, 2020, entitled “Systems, Methods and Devices for Facilitating Electronic Communications and Information Sharing for Shareholders,” and claims priority to U.S. Patent Application Ser. No. 63/114,437, filed Nov. 16, 2020, entitled “Systems, Methods and Devices for Data Communication Protocol Platform,” the entire contents of each of which are hereby incorporated by reference in their entirety.

### FIELD

The present application relates to systems, methods, and devices for a data communications protocol platform, for example to facilitate electronic communications and information sharing among one or more electronic databases and/or interfaces.

### BACKGROUND

Publicly traded companies (or corporations) are required to hold annual meetings. The companies may also hold interim meetings as needed. The annual meetings typically serve to acquire shareholder and/or bond holder approval on proposals related to the company's affairs, operations, management, or the like. Moreover, the company may hold other meetings and/or consent solicitations whenever shareholder or bondholder approval is necessary, such as for takeovers, buyouts, or the like. Typically, the routine to conduct such proceedings may include: setting a date; submitting filings for the meeting; receiving and tabulating shareholders' votes for shareholders or bond holders such as individuals, companies, groups, etc. In many situations, a separate company may be hired to facilitate the overall process.

Currently, if a company, a dissident shareholder, or another third-party wishes to affect the voting results for an annual meeting, for example, agents are often hired to contact shareholders or bond holders to deliver a message for solicitation purposes. The agent may be known as a “Solicitor.” Often, the Solicitor contacts shareholders or bond holders by mail or telephone. Sometimes public media is used if a large shareholder/bondholder base is at issue. These initiatives could be expensive (e.g., full page ads in a national paper) and inexact. Similarly, shareholders wishing to undertake an initiative for a shareholder vote often face a battle with the company management in which neither side clearly knows their level of support until all proxy votes are tabulated and released. Substantial resources may be required to garner support for an issue and for the legal maneuverings to submit the issue for a vote.

Generally, proxy voting systems can be highly regulated and can involve a rigid customer voting experience. In the near term, there can be limited room to make the experience more engaging and useful within the framework of formal proxy solicitation and voting. A need therefore exists for enabling shareholders to vote by proxy while simultaneously providing voting recommendations in view of market trends or consensus amongst other shareholders for each share issue provider.

### SUMMARY

According to an embodiment of the present disclosure there is provided a method performed by a server, the method comprising obtaining share portfolio information for one or more shareholders from a broker database, obtaining proxy voting requirements from at least one share issuer, receiving shareholder preference data from the one or more shareholders, generating proxy vote recommendations based on the share portfolio information, proxy voting requirements and the shareholder preference data, and providing the proxy vote recommendations to an interactive graphical interface of a shareholder access point of each of the one or more shareholders using Application Programming Interface (API).

According to another embodiment of the present disclosure there is provided a computer program product comprising computer-readable code embodied in a non-transitory computer-readable storage medium which, when executed by one or more processors of a computing device, causes the computing device to perform a method comprising obtaining share portfolio information for one or more shareholders from a broker database, obtaining proxy voting requirements from at least one share issuer, receiving shareholder preference data from the one or more shareholders, generating proxy vote recommendations based on the share portfolio information, proxy voting requirements and the shareholder preference data, and providing the proxy vote recommendations to an interactive graphical interface of a shareholder access point of each of the one or more shareholders using Application Programming Interface (API).

In some implementations, the method further comprises providing proxy votes directly to the at least one share issuer on behalf of at least a portion of the one or more shareholders based on the proxy vote recommendations using API. In certain implementations, the method further comprises enabling the shareholder to proxy vote using the interactive graphical interface on their respective shareholder access point either (i) without the proxy vote recommendations, or (ii) with certain proxy vote recommendations. In other implementations, the method further comprises consolidating the proxy votes on the server based on aggregated proxy votes received from the one or more shareholders via API.

In further implementations, the method further comprises providing polls to the one or more shareholders via API to obtain shareholder opinions. In some implementations, the method further comprises using the poll data to generate the proxy vote recommendations. In certain implementations, the share portfolio information does not contain personally identifiable information of the one or more shareholders. In certain implementations, the proxy voting requirements include adherence to at least one of 14a-8 shareholder proposal requirements, schedule 13D requirements, and U.S. Securities and Exchange Commission requirements (Staff Legal Bulletin No. 20 (IM/CF)). In other implementations, the shareholder preference data comprises an aggregation of data from a population of shareholders. In some implementations, the shareholder access point comprises a mobile device.

### BRIEF DESCRIPTION OF DRAWINGS

The foregoing and other objects and advantages will be apparent upon consideration of the following detailed description, taken in conjunction with the accompanying drawings, in which like reference characters refer to like parts throughout, and in which:

FIG. 1 illustrates a schematic diagram of a system for facilitating the electronic communications and information sharing, according to one or more embodiments of the present disclosure;

FIG. 2 shows a block diagram of computer hardware systems configured to run software for facilitating electronic communications and information sharing, according to one or more embodiments of the present disclosure;

FIG. 3 shows a flowchart illustrating an overview of one or more embodiments of methods for facilitating electronic communications and information sharing;

FIG. 4 illustrates a flowchart illustrating Phase II of a method for facilitating electronic communications and information sharing of FIG. 3, according to one or more embodiments of the present disclosure;

FIG. 5 illustrates Phase III of a method for facilitating electronic communications and information sharing of FIG. 3, according to one or more embodiments of the present disclosure;

FIG. 6 is a schematic diagram illustrating the generation of proxy vote recommendations and delegation of automated proxy voting using the system of FIG. 1, according to one or more embodiments of the present disclosure;

FIG. 7 illustrates an exemplary Q&A platform used in the system of FIG. 1, according to one or more embodiments of the present disclosure;

FIG. 8 illustrates an exemplary polling platform used in the system of FIG. 1, according to one or more embodiments of the present disclosure;

FIG. 9 shows features of a metric or score generation framework used in the system of FIG. 4, according to one or more embodiments of the present disclosure;

FIG. 10 shows features of one or more basic action metrics that can be utilized by the system of FIG. 1 to generate the metric or score in FIG. 9, according to one or more embodiments of the present disclosure;

FIG. 11 shows features of an activist assailability score that can be utilized by the system of FIG. 1 to generate the metric or score in FIG. 9, according to one or more embodiments of the present disclosure;

FIG. 12 shows features of an activist likelihood score that can be utilized by the system of FIG. 1 to generate the metric or score in FIG. 9, according to one or more embodiments of the present disclosure;

FIG. 13 shows features of a share price/press reaction sensitivity indicator that can be utilized by the system of FIG. 1 to generate the metric or score in FIG. 9, according to one or more embodiments of the present disclosure;

FIG. 14 shows features of a shareholder participation score that can be utilized by the system of FIG. 1 to generate the metric or score in FIG. 9, according to one or more embodiments of the present disclosure;

FIG. 15 shows features of an environmental, social, and governance (ESG) price effect that can be utilized by the system of FIG. 1 to generate the metric or score in FIG. 9, according to one or more embodiments of the present disclosure;

FIG. 16 shows features of a robo score that can be utilized by the system of FIG. 1 to generate the metric or score in FIG. 9, according to one or more embodiments of the present disclosure;

FIG. 17 shows features of a millennial/age score that can be utilized by the system of FIG. 1 to generate the metric or score in FIG. 9, according to one or more embodiments of the present disclosure;

FIG. 18 illustrates the flow of data in the communications platform of the system in FIG. 1 for generating the one or more scores and/or metrics in FIG. 9, according to one or more embodiments of the present disclosure;

FIG. 19 illustrates the generation of an activist likelihood score by the communications platform of the system in FIG. 1, according to one or more embodiments of the present disclosure;

FIG. 20 illustrates the generation of an activist assailability score by the communications platform of the system in FIG. 1, according to one or more embodiments of the present disclosure;

FIG. 21 illustrates the generation of an activist risk score by the communications platform of the system in FIG. 1, according to one or more embodiments of the present disclosure;

FIG. 22 is a schematic diagram illustrating features of protecting personally identifiable information (PII) by the system of FIG. 1, according to one or more embodiments of the present disclosure;

FIG. 23 is a flowchart illustrating voter authentication carried out by the system of FIG. 1, according to one or more embodiments of the present disclosure;

FIG. 24 is a flowchart illustrating point-in-time voting carried out by the system of FIG. 1, according to one or more embodiments of the present disclosure;

FIG. 25 is a flowchart illustrating real voting carried out by the system of FIG. 1, according to one or more embodiments of the present disclosure; and

FIG. 26 is a flowchart illustrating a method executed by the system in FIG. 1 for providing proxy vote recommendations, according to one or more embodiments of the present disclosure.

### DETAILED DESCRIPTION

Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Various embodiments described herein relate to systems, methods, and devices for a data communications protocol platform for facilitating electronic communications and information sharing, such as to, from, and/or among shareholders or other stakeholders. In particular, some embodiments described herein relate to systems, devices, and methods for dynamically generating a top level score, such as for example an activist risk score, of a company based on certain inputs and using the score to dynamically generate and provide proposed responses to a user. In some embodiments, the systems, devices, and methods described herein relate to a communications protocol that facilitates communications to shareholder and/or other stakeholders without accessing or having knowledge of personally identifiable information (PII).

Data Communications Protocol Platform System

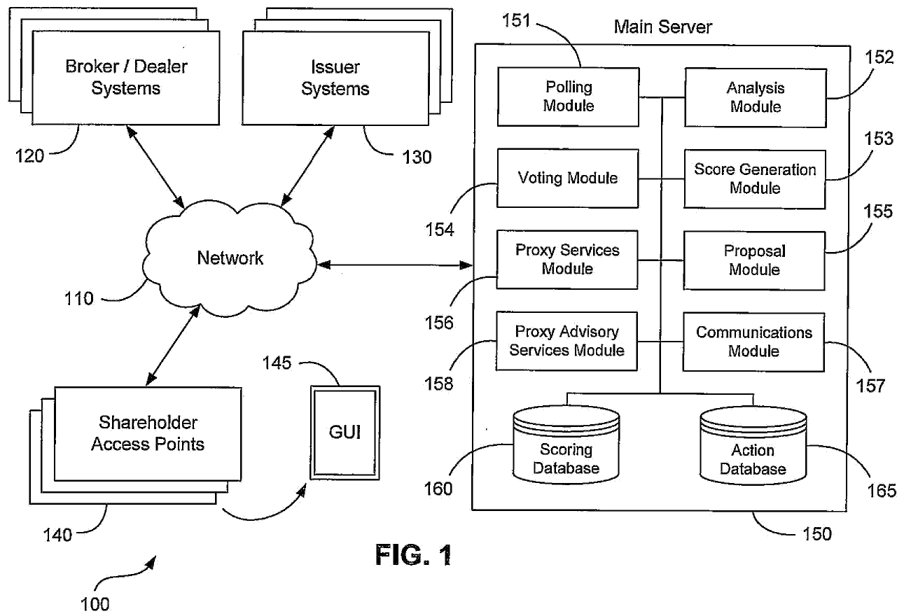

FIG. 1 is a schematic diagram illustrating one or more embodiments of a data communications protocol system 100 according to an embodiment of the present disclosure. The system comprises a main server 150 connected to a network 110 which enables the server 150 to be communicatively coupled to broker/dealer systems 120, share issuer systems 130 and shareholder access points 140. In some embodiments, the shareholder access points 140 may comprise devices having an interactive graphical interface GUI 145, such as a smartphone or a tablet computer, for example. In some embodiments, the main server system 150 may comprise a plurality of modules that are communicatively coupled together. These module may include a polling module 151, an analysis module 152, a score generation module 153, a voting module 154, proposal module 155, a proxy services module 156, a communications module 157, and a proxy advisory module 158. The main server 150 may also comprise scoring database 160 and an action database 165.

Computer System

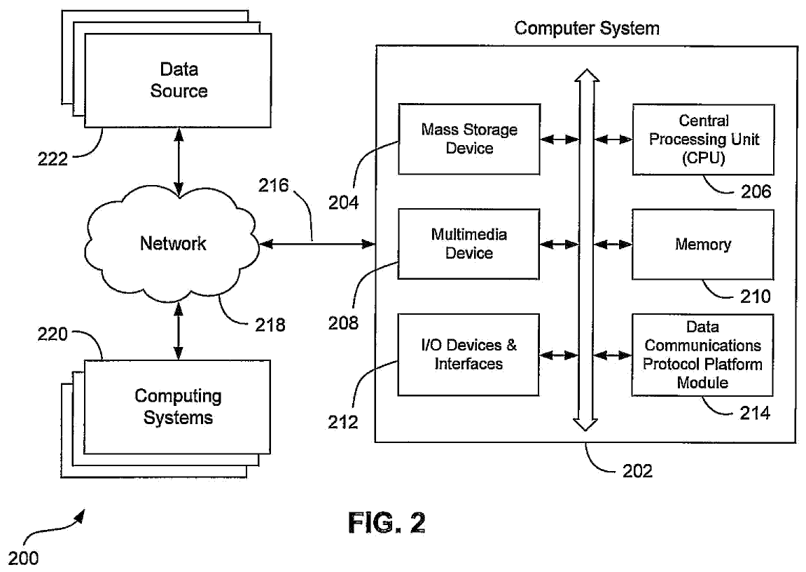

In some embodiments, one or more systems, processes, and methods described herein are implemented using a computing system 202, as shown in FIG. 2. Computer system 202 comprises a mass storage device 204, a central processing unit (CPU) 206, a multimedia device 208, a memory 210, input-output devices and interfaces 212, as a typically found in a computing system. These components are communicatively coupled with each other via a central bus. The computing system 202 may also comprise a data communications protocol platform module 214. Data communications protocol platform module 214 carries out the functions, methods, and/or processes described herein. The data communications protocol platform module 214 may comprise a series of computer executable instructions that is executed on the computer system 202 by a central processing unit 206 discussed further below. Computer system 202 may be in communication with one or more computing systems 220 and/or one or more data sources 222 via one or more networks 218. While FIG. 2 illustrates an embodiment of a computing system 202, it is recognized that the functionality provided for in the components and modules of computer system 202 can be combined into fewer components and modules, or further separated into additional components and modules. Computer system 202 may also be used as a main server, such as server 150 shown in FIG. 1.

Computing System Components

The computer system 202 includes one or more processing units (CPU) 206, which may comprise a microprocessor. The computer system 202 further includes a physical memory 210, such as random access memory (RAM) for temporary storage of information, a read only memory (ROM) for permanent storage of information, and a mass storage device 204, such as a backing store, hard drive, rotating magnetic disks, solid state disks (SSD), flash memory, phase-change memory (PCM), 3D XPoint memory, diskette, or optical media storage device. Alternatively, the mass storage device can be implemented in an array of servers. The components of the computer system 202 may be connected together using a bus. The bus may be implemented using various protocols, such as Peripheral Component Interconnect (PCI), Micro Channel, SCSI, Industrial Standard Architecture (ISA) and Extended ISA (EISA) architectures.

The computer system 202 includes one or more input/output (I/O) devices and interfaces 212, such as a keyboard, mouse, touch pad, and printer. The I/O devices and interfaces 212 may include one or more display devices, such as a monitor, that allows the visual presentation of data to a user. More particularly, a display device provides for the presentation of GUIs as application software data, and multi-media presentations, for example. The I/O devices and interfaces 212 may also provide a communications interface to various external devices. The computer system 202 may comprise one or more multi-media devices 208, such as speakers, video cards, graphics accelerators, and microphones, for example.

Computing System Device/Operating System

The computer system 202 may run on a variety of computing devices, such as a server, a Windows server, a Structure Query Language server, a Unix Server, a personal computer, a laptop computer, and so forth. In other embodiments, the computer system 202 may run on a cluster computer system, a mainframe computer system and/or other computing system suitable for controlling and/or communicating with large databases, performing high volume transaction processing, and generating reports from large databases. The computing system 202 may generally be controlled and coordinated by an operating system software, such as z/OS, Windows, Linux, UNIX, BSD, PHP, SunOS, Solaris, MacOS, iCloud services or other compatible operating systems, including proprietary operating systems. Operating systems control and schedule computer processes for execution, perform memory management, may provide file system, networking, and I/O services, and provide a user interface, such as a graphical user interface (GUI), among other things.

Network

The computer system 202 illustrated in FIG. 2 may be coupled to a network 218, such as a LAN, WAN, or the Internet via a communication link 216 (wired, wireless, or a combination thereof). Network 218 communicates with various computing devices and/or other electronic devices. Network 218 is communicating with one or more computing systems 220 and one or more data sources 222. The data communications protocol platform module 214 may access or may be accessed by computing systems 220 and/or data sources 222 through a web-enabled user access point. Connections may be a direct physical connection, a virtual connection, and other connection type. The web-enabled user access point may comprise a browser module that uses text, graphics, audio, video, and other media to present data and to allow interaction with data via the network 218.

The output module may be implemented as a combination of an all-points addressable display such as a cathode ray tube (CRT), a liquid crystal display (LCD), a plasma display, or other types and/or combinations of displays. The output module may be implemented to communicate with input devices 212 and they may also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module can communicate with a set of input and output devices to receive signals from the user.

Other Systems

The computing system 202 may include one or more internal and/or external data sources (for example, data sources 222). In some embodiments, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 202 may also access one or more databases 222. The databases 222 may be stored in a database or data repository. The computer system 202 may access the one or more databases 222 through a network 218 or may directly access the database or data repository through I/O devices and interfaces 212. The data repository storing the one or more databases 222 may reside within the computer system 202.

Score/Metric Generation Systems, Devices, and Methods

In some embodiments, the system is configured to generate one or more metrics and/or scores based on one or more sub-metrics and/or data that is collected and/or compiled and/or analyzed using one or more embodiments of the systems, devices, and methods for a data communications protocol platform. More specifically, in some embodiments, the system can be configured to leverage one or more capabilities and/or sources of data, such as for example Q&A and polls tools, to generate one or more metrics. In some embodiments, the metric can incorporate certain contributing sub-metrics that can be tied to measurable outcomes. In some embodiments, the metric can incorporate certain publicly available information or metrics related to shareholder behavior. In some embodiments, one or more sub-metrics can be rolled up into a single or a series of top-line metrics. In some embodiments, a particular sub-metric can be used as is. In some embodiments, one or more sub-metrics can allow the system or user to gauge investor behavior, sentiment, and/or demographics.

In general the word “module,” as used herein, refers to logic embodied in hardware or firmware or to a collection of software instructions, having entry and exit points. Modules are written in a program language, such as JAVA, C, or C++, or the like. Software modules can be compiled or linked into an executable program, installed in a dynamic link library, or can be written in an interpreted language such as BASIC, PERL, LAU, PHP or Python and any such languages. Software modules can be called from other modules or from themselves, and/or can be invoked in response to detected events or interruptions. Modules implemented in hardware include connected logic units such as gates and flip-flops, and/or can include programmable units, such as programmable gate arrays or processors.

Generally, the modules described herein refer to logical modules that can be combined with other modules or divided into sub-modules despite their physical organization or storage. The modules are executed by one or more computing systems, and can be stored on or within any suitable computer readable medium, or implemented in-whole or in-part within special designed hardware or firmware. Not all calculations, analysis, and/or optimization require the use of computer systems, though any of the above-described methods, calculations, processes, or analyses can be facilitated through the use of computers. Further, in some embodiments, process blocks described herein can be altered, rearranged, combined, and/or omitted.

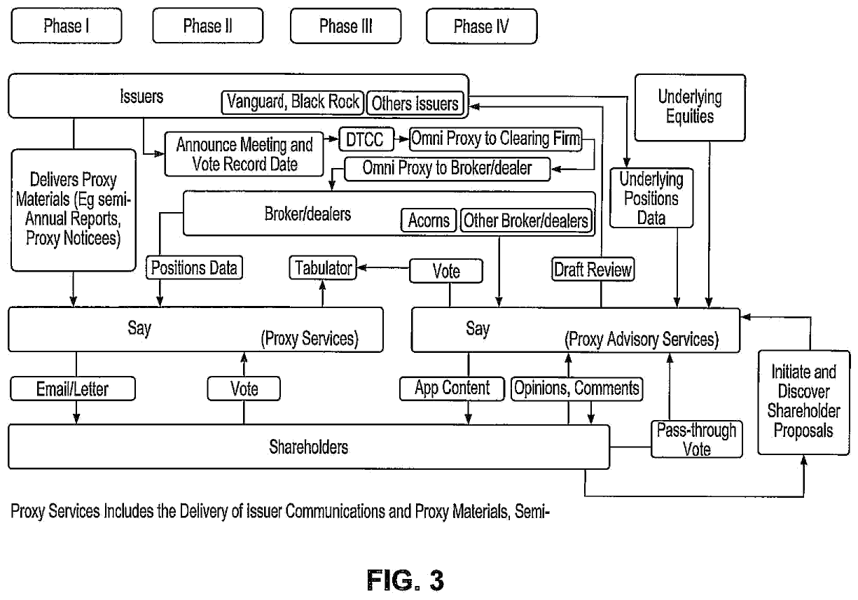

Additionally, embodiments described herein relate to systems, methods, and devices for facilitating electronic communications and information sharing, such as to, from, and/or among shareholders. In particular, some embodiments described herein relate to proxy services and/or proxy advisory services for shareholders. Proxy services can refer to the delivery of issuer communications and proxy materials, semi-annual reports and proxy notices, and/or other related services. Proxy advisory services can refer to advising shareholders, which can be institutions, on voting their shares or holdings based on their research, compliance, and/or review, and/or other related services. FIG. 3 is a flowchart illustrating an overview of one or more embodiments of methods for facilitating electronic communications and information sharing, such as to, from, and/or among shareholders that are described in relations to Phases I-IV.

Phase I

In some embodiments, the systems, methods, and devices can be configured to deliver shareholder communications on a platform, such as a mobile or web-based platform. In addition, in certain embodiments, the systems, methods, and devices can be configured to aggregate securities positions data on a platform, such as a mobile or web-based platform.

Phase II

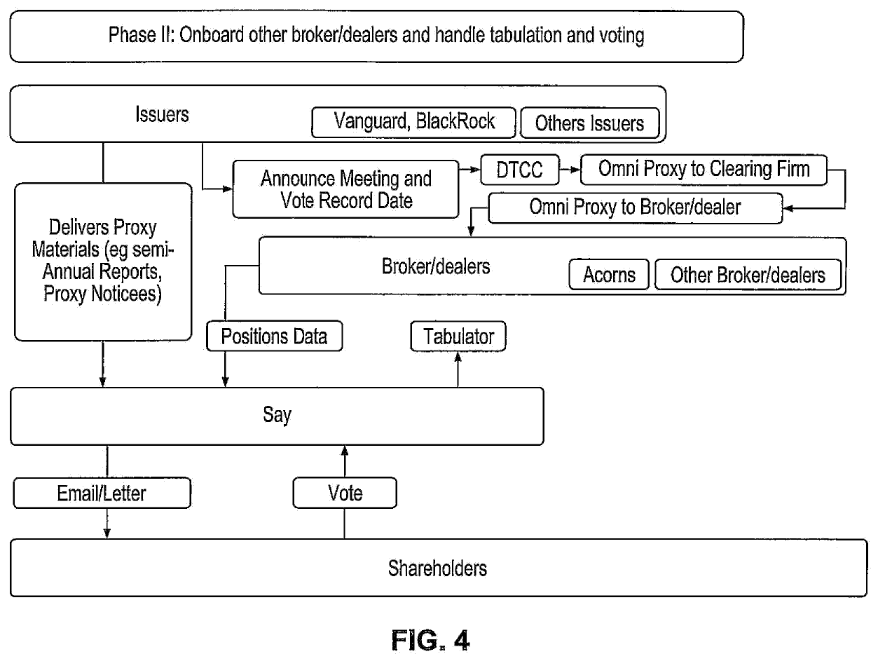

FIG. 4 is a flowchart illustrating Phase II of one or more embodiments of methods for facilitating electronic communications and information sharing of FIG. 3. As illustrated, in some embodiments, the systems, methods, and devices can be configured to administer shareholder proxy voting on a platform, such as a mobile or web-based platform. Further, in certain embodiments, the systems, methods, and devices can be configured to tabulate votes and/or pass voting data to a third-party tabulator.

Phase III

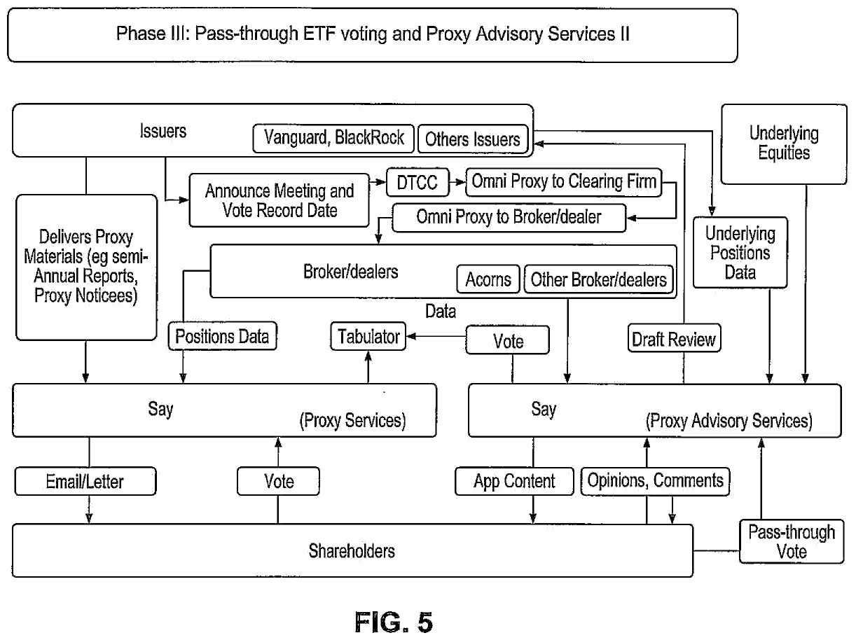

FIG. 5 is a flowchart illustrating Phase III of certain one or more embodiments of methods for facilitating shareholder electronic communications and information sharing of FIG. 3.

As illustrated, in some embodiments, the systems, methods, and devices described herein can be configured to aggregate and/or predict user or shareholder interests and/or preferences. In certain embodiments, the systems, methods, and devices can be configured to collect user or shareholder preferences and/or interests to create a profile, which can further be used to suggest relevant queries and/or responses from a larger set. In certain embodiments, the systems, methods, and devices can be configured to aggregate user or shareholder preferences and/or advise issuers and/or users or shareholders on how to vote based on such preferences. In certain embodiments, the systems, methods, and devices can be configured to select and/or translate one or more sets of proxy vote queries into one or more sets of issues queries based on a user or shareholder profile. In certain embodiments, the systems, methods, and devices can be configured to automatically generate a shareholder or user profile based on personal information.

In certain embodiments, the systems, methods, and devices can be configured to identify and/or form a syndicate of shareholders, for example to meet ownership percentage and/or duration thresholds. For example, such systems, methods, and devices can further be configured to generate 13D, notify shareholder(s), and/or facilitate shareholder proposal processes. In certain embodiments, the systems, methods, and devices can be configured to select and/or aggregate a pool of shareholders based on their profiles. In certain embodiments, the systems, methods, and devices can be configured to integrate corporate governance data. For example, some systems, methods, and devices can be configured to determine which database(s) to access and/or select a particular form of data transmission or the like. Further, some systems, methods, and devices can be configured to combine corporate governance data with user interests and/or preferences to arrive at a decision and/or action.

In certain embodiments, the systems, methods, and devices can be configured to collect votes and/or preferences from exchange traded fund (ETF) holders and distribute a tally of votes and/or preferences to an ETF, for example using a platform, such as a mobile or web platform, and/or utilizing a blockchain tallying system. In certain embodiments, the systems, methods, and devices can be configured to allow a single holder to simultaneously vote on both an individually directly-held position and on the same position as held in an ETF. In certain embodiments, the systems, methods, and devices can be configured to combine pass-through issue-preference voting and direct votes for the same security.

In certain embodiments, the systems, methods, and devices can be configured to generate a proxy vote(s) for an individual and/or pool of individuals. In certain embodiments, the systems, methods, and devices can be configured to analyze a portfolio to determine whether it is compatible with the systems, methods, and devices herein. In certain embodiments, the systems, methods, and devices can be configured to allow for routing of an account to a broker dealer and/or introduce securities that use one or more systems, methods, and devices herein.

In certain embodiments, the systems, methods, and devices can be configured to connect an index of companies with an ETF on an issue- and/or voting-level, interface with a social network(s), generate determinations, and/or direct voting instructions or votes on the underlying issues on a proprietary or closed platform. In certain embodiments, the systems, methods, and devices can be configured to connect an investment application and/or investment viewing portal with an investor communications tool triggering notifications based on account log-in or use activity. In certain embodiments, the systems, methods, and devices can be configured to connect an investment application and/or financial transaction aggregator. In certain embodiments, the systems, methods, and devices can be configured to generate an investment recommendation based on user profile or activity.

Phase IV

In certain embodiments, the systems, methods, and devices can be configured to facilitate shareholder proposals on a platform, such as a mobile or web-based platform.

Say Advisor—Advisory Systems, Methods, and Devices

In some embodiments, one or more systems, methods, and devices described herein can be configured to provide proxy voting services to shareholders, such as individuals. In particular, in certain embodiments, one or more systems, methods, and devices described herein can be configured to provide automated, semi-automated, and/or delegated proxy voting services for shareholders based on, for example, interactions with and/or input from shareholders and/or other information. More specifically, in certain embodiments, one or more systems, methods, and devices described herein can be configured to receive and/or aggregate interactions and/or input from shareholders and/or other information, which can be translated automatically, semi-automatically, dynamically, and/or manually into actionable data for investment advisors and/or proxy votes.

Generally, proxy voting systems can be highly regulated and can involve a rigid customer voting experience. In the near term, there can be limited room to make the experience more engaging and useful within the framework of formal proxy solicitation and voting. As such, some embodiments herein provide a different solution to address such shortcomings. In particular, certain systems, methods, and devices described herein can be configured to provide year-round shareholder engagement with companies, outside of the formal meeting context. In addition, certain systems, methods, and devices described herein can be configured to provide engagement with companies on a wide range of issues, regardless of whether they are 14a-8 proposals on an actual proxy. Further, certain systems, devices, and methods described herein can be configured to provide the ability for shareholders to initiate their own proposals and suggestions, which is referred to herein as “Sayholder Proposals,” without the onerous 14a-8 requirements. Furthermore, certain systems, devices, and methods described herein can be configured to provide a social experience where shareholder can interact with each other and aggregate their voices outside of a formal meeting, which is referred to herein as “Sayholder Meetings.” Moreover, certain systems, devices, and methods described herein can be configured to provide an opposite experience from filling out a VIF, which can be intuitive, engaging, and/or empowering.

In some embodiments, the system can be configured to shift complexity and/or regulatory burden off of individual shareholders and onto the system, thereby creating and providing a new experience for shareholders from a clean slate. In certain embodiments, the system can be configured to end the chain of proxy voting authority at the system and not extend it through to the customer. As such, in certain embodiments, the customer may never actually cast formal proxy votes. Rather, in certain embodiments, customers may simply interact with the a user access point of the system, such as a mobile application and/or website, after which the system can be configured to translate those inputs into actionable data for investment advisers, which are referred to herein as IA, and/or others to use in making proxy voting and engagement decisions.

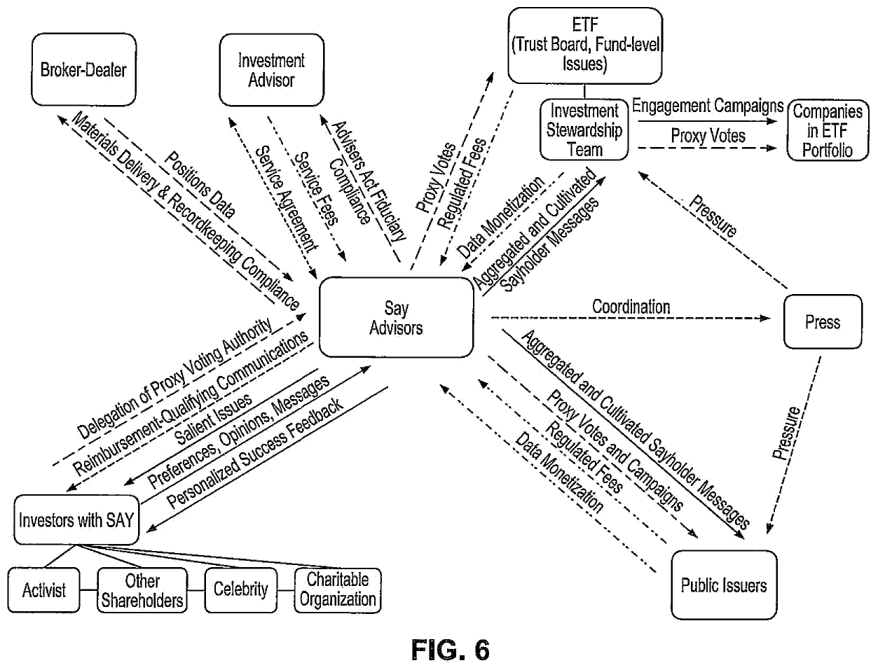

FIG. 6 is a schematic diagram illustrating one or more embodiments of the advisory systems, methods, and devices of the present disclosure. FIG. 6 shows exemplary interactions between the SayAdvisor of the present disclosure and various entities such as broker-dealers, investment advisors, share issuers and governing bodies, and investors.

Proxy Voting

In some embodiments, the system can be configured to provide one or more proxy voting services. In particular, in certain embodiments, the system can be configured to work with investment advisors (IA) who retain voting authority for all clients (“Voting IAs”) and/or IAs who pass voting authority through to their clients (“Pass-Through Voting IAs”). In certain embodiments, the system can be configured to minimize disruption at potential clients in integrating with the system. For example, in some embodiments, the system can be configured to minimize amendments to Form ADV, client advisory agreements, structure, and/or the like. In some embodiments, the system can be configured to encourage or require all IA clients to become Voting IAs in order to integrate with the system.

In certain embodiments, the system can be configured to generate proxy vote recommendations for Voting IAs based on information received from a user access point system, such as a mobile application or website, and/or vote proxies directly on behalf of the IA (the “proxy voting sub-adviser”). In some embodiments, the system can be configured to split proxy vote recommendations and/or votes pro rata to reflect a diversity of opinions amongst Voting IA clients. In certain embodiments, the system can be configured to query whether it is preferable to aggregate data from the entire population of users across multiple IAs in generating recommendations. In some embodiments, the system can be configured to adhere to framework laid out in Staff Legal Bulletin No. 20 (IM/CF).

In certain embodiments, the system can be configured to allow clients of Pass-Through Voting IA's to choose to: (i) vote proxies directly, without input from the system; (ii) allow the system to vote proxies directly on their behalf based on information from the app; and/or (iii) receive certain voting recommendations from the system, based on their profile, without voting shares directly.

In some embodiments, the system can be configured to be replicated for IA clients as a white label product.

Engagement with Public Companies

In some embodiments, the system can be configured to facilitate engagement with public issuers, outside of the formal meeting context and the proxy rules. This can have many critical benefits. For example, this can enable the rich, engaging feature set that would be impossible within the proxy framework, including Sayholder Proposals and Sayholder Meetings. In addition, this can enable engaging customers of broker-dealers and IAs who are unable to turn on formal proxy voting through the system, for example, because of a long-term contract with proxy services competitor. Furthermore, this can enable engagement of shareholders even if the system has no relationship with their broker-dealer or IA, through direct Quovo connection to an individual's brokerage account.

In certain embodiments, the system can comprise an issuer “portal” for companies to claim their space, participate, and initiate their own inquiries, surveys, and/or data gathering exercises.

Engagement with Fund Stewardship Groups

In some embodiments, the system can be configured to facilitate engagement with investment stewardship groups at ETF and mutual fund managers and, indirectly, with the individual companies underlying those funds. Generally speaking, due to their investment strategy, index funds are not able to sell shares when they disagree with company management or are dissatisfied with a company's performance. As a result, index funds can be some of the most actively engaged institutional shareholders and frequently weigh in on issues facing the companies they invest in. Yet they may rely on relatively small investment stewardship groups and the advice of. Institutional Shareholder Services (ISS) and Glass Lewis to vote trillions of dollars of wealth and engage with thousands of companies.

As such, in certain embodiments, the system is configured to engage fund owners, the ultimate source of the investment dollars and the beneficiaries of the advisor's fiduciary obligations, to provide input on the fund's voting and engagement activities. In some embodiments, the system can be configured to deliver aggregated and cultivated data on the preferences and opinions of the fund owners to the fund governance groups. Such funds could be referred to as “Say direct engagement funds.” In certain embodiments, for such Say direct engagement funds, the system can be configured to either not charge any engagement-related fees because they would vote proxies as directed by their investors through the system and/or charge the same shareholder engagement-related fees as other funds, however take shareholder preferences into account when voting their shares.

Source of. Information

In some embodiments, the system can be configured to gather data from one or more sources in order to make voting decisions and recommendations for one or more use cases described above. For example, in certain embodiments, the system can be configured to gather data from a user access point system, such as a mobile application or website, the system's proxy processing business, which can be referred to herein as the “Proxy Processor,” and/or news sources, social media, and/or Voting “Brands.” The system may or may not be configured to make formal shareholder proposals, such as those governed by Rule 14a-8, on behalf of clients.

In certain embodiments, the system can be configured to utilize brokerage account ownership data. In some embodiments, the system can be configured to enable IAs to allow their clients to become users of a mobile application or website or other user access point for the system. For example, in certain embodiments, the system can be configured to enable users to log into their brokerage accounts through the system's user access point, such as a mobile application and/or website. In some embodiments, the system can be configured to enable users to access the system user access point through their brokerage account.

In some embodiments, the system can be configured to automatically, semi-automatically, dynamically, and/or manually import information regarding users' investment portfolios once the users log in. For example, such user information may comprise users' ownership interests in single-issuer securities, mutual funds, and/or ETFs. Investments other than single-issuer securities (i.e., ETFs) may be broken down such that users are shown their ownership interest in the securities underlying the applicable investment vehicle as well as their ownership of the ETF itself.

In certain embodiments, for purposes of the user experience on the application or other user access point, direct and indirect ownership of single-issuer securities may not be differentiated. In some embodiments, users with an indirect beneficial interest in a single-issuer security may be presented their interest in such security as if they held such security directly. In certain embodiments, investments may be aggregated and broken down to the extent possible in order to provide the widest possible set of engagement methods.

In some embodiments, a standard metric may be assigned to users' ownership interests that will allow for their investments to be expressed in a uniform way in their interactions with one another. This metric may be as simple as the dollar value of their investments, some factor of the value of their investments, and/or a flat per-user metric (such as a “like” button). Whatever the metric, the metric can be configured to roughly approximate users' shareholder voting power while maintaining flexibility for active engagement and preventing unwanted disclosure of the value of a user's investment portfolio.

In some embodiments, the system can be configured to utilize user proposal data. More specifically, in certain embodiments, once they have imported their financial data into the application, users can then have the opportunity to submit Sayholder Proposals for consideration and engage with Sayholder Proposals made by others. Sayholder Proposals can be an opinion, recommendation, endorsement, and/or statement regarding a company or investment entity's practices, or a broader practice or trend within the economy.

In certain embodiments, users can be provided with flexibility in crafting Sayholder Proposals, however they can be subject to certain guidelines that will help ensure that they are related in some way to a company or investment entity's practices. In some embodiments, Sayholder Proposals must ultimately be good candidates for the form of investment-based engagement that the application will enable.

In some embodiments, engagement can take the form of users putting their investments behind a Sayholder Proposal. The system can be configured to allow Sayholder Proposals to gather support and engagement from app or other user access point users. This engagement data can form a core part of the system's generation of voting decisions and recommendations in one or more use cases described above.

In certain embodiments, the system can be configured to utilize Proxy Processor data. In some embodiments, the Proxy Processor business segment can handle beneficial shareholder communications and/or voting for broker-dealers in connection with public company annual and special meetings, consent solicitations, investment company fund report distributions, fund votes, and/or other events for which materials must be forwarded to beneficial shareholders. In the course of providing this service, the Proxy Processor can obtain information regarding shareholder voting habits and shareholder demographics. In some embodiments, subject to privacy and use restrictions, the Proxy Processor can be configured to pass this information to the system where it could provide insight for the generation of voting and engagement decisions.

In some embodiments, the system can be configured to utilize news, social media voting “brands” and/or other sources. In particular, in certain embodiments, the system can be configured to import information regarding issues affecting companies in which users are invested from a variety of news and social media sources. For example, trending topics on social media web sites or breaking news stories that use the name of companies that users are invested in may be presented to users. In some embodiments, data from existing user profiles on social media websites can be imported. Information from news or social media sources may be presented to users in its raw form or processed by the application to then be presented as a Sayholder Proposal.

In certain embodiments, the system can be configured to allow institutional investors who are willing to make their voting guidelines public to serve as “brand names” or thought leaders for Sayholder Proposals. In some embodiments, the system can be configured to utilize prior votes by institutional investors and/or investment advisors, for example as a source of data in order to train the application voting model. In certain embodiments, the system can be configured to utilize other potential leading voices, such as celebrities, political leaders, charitable groups, and/or other public voices that would be willing to make or support Sayholder Proposals.

Integration Details

In some embodiments, the system can be configured to electronically communicate with and/or be integrated with one or more Voting IAs. More specifically, in certain embodiments, the system can be configured such that one or more Voting IAs can enable client login to the system or a user access point thereof, such as a mobile application or website, such that brokerage account information can be imported. In some embodiments, one or more Voting IAs can be configured to update proxy voting policy and indicate that it is receiving proxy voting recommendations from the system, or that the system is directly voting shares on behalf of clients instead of the Voting IA.

In certain embodiments, the system can comprise one or more dashboards created for Voting IAs to access voting decisions made by the system on their clients' behalf. In some embodiments, detailed voting records can be made available on-demand. In addition, in some embodiments, Voting IAs can have the ability to remove voting authority from the system at any time, for example to comply with Staff Legal Bulletin No. 20 (IM/CF).

In some embodiments, the system can be configured to electronically communicate with and/or be integrated with one or more Pass-Through Voting IAs. More specifically, in certain embodiments, the system can be configured such that one or more Pass-Through Voting IAs can enable client login to the system or a user access point thereof, such as a mobile application or website, so that brokerage account information can be imported. In some embodiments, the system can be configured such that one or more Pass-Through Voting IAs can advise clients that they now have the option to (i) vote without input from the system, (ii) obtain recommendations from the system regarding votes, and/or (iii) delegate voting authority fully to the system. In some embodiments, the system can be configured such that shareholder materials are always be provided to shareholders. In certain embodiments, the system can be configured such that clients can always have the ability to review voting decisions and reject a voting decision made by the system.

In certain embodiments, the system can be configured such that Shareholders would still receive the same shareholder communications they would have if they voted the shares themselves and would be presented with a summary of any vote to be taken on their behalf prior to its being cast, as well as an opportunity to retract or override such vote.

It can be important to recognize the difference between certain systems described herein and client-directed voting as has been previously proposed. In some embodiments, these voting recommendations described herein are not standing voting instructions (i.e., “always vote no on certain proposals”). Instead, in some embodiments, they are dynamically and/or automatically generated based on user interaction with the user access point system, such as a mobile application or website, and are not preset in any way.

In addition, in some embodiments, a user access point application or website interface can allow for users to easily reject suggested proposals made by the system on an ongoing basis. In certain embodiments, the system can be configured to initiate and/or utilize push notifications to advise users of upcoming votes, and votes would not be cast without approval. Without a user access point interface, obtaining such approval can be cumbersome and difficult to achieve.

In generally, IAs have fiduciary duties to their clients. If an IA retains voting authority over its clients' shares, it must vote proxies in the client's best interest. Almost all IAs that retain voting authority follow the proxy voting recommendations of one of the two main proxy advisory firms, ISS or Glass Lewis.

These two firms advise on an enormous volume of shareholder votes each year. Given the size of their respective staffs and the number of votes they advise on, it is not possible for most investment advisers to receive voting advice that has truly been tailored to suit the particular needs or points of view of their clients. It is important to note that proxy advisory firms make voting recommendations that could be considered preference- or viewpoint-susceptible.

For example, some IA clients may feel strongly that the use or production of fossil fuels is detrimental. An IA client with such a belief would probably be dismayed to find that an IA that has retained voting authority on their behalf did not support a 14a-8 shareholder proposal requesting that a fossil fuel producing company detail their plans to invest in alternative fuel sources. Consider also an IA client horrified by recent privacy scandals at public companies, many of which have gone on to face shareholder proposals regarding such topics. A vote against a proposal to create an independent committee on privacy matters at the Company would probably be strongly supported by such an individual.

On matters subject to 14a-8 shareholder proposals for which IA clients have strong opinions that are discernible using the data sources described above, simply voting client shares in line with the advice of a proxy advisory firm may not be equivalent to acting in their best interests, and indeed may be contrary to their best interests.

Furthermore, ISS in particular consults for public companies on shareholder votes. The fact that they make recommendations to institutional investors and IAs on the very same votes presents a serious conflict of interest which has been widely commented upon. This conflict of interest touches directly upon a fundamental right held by shareholders.

The retention of voting authority at the Investment Advisor level also strips IA clients of the ability to actively participate in a fundamental shareholder right. Many clients, especially at tech forward robo-advisors targeting younger investors, may not even be aware that they have the right to vote in annual meetings. The decision to invest through such a platform is often based upon such investors' comfort with web-based platforms as well as ease of use and cost considerations. Investors should not be required to forfeit their voting rights in order to use one of these platforms.

Finally, the new breed of IA's known as “Robo-Advisors” challenge the applicability of the Rule 3a-4 “safe harbor” from registration as an Investment Company under the Investment Company Act. This safe harbor sets out guidelines that attempt to determine whether client accounts at an IA are sufficiently differentiated such that they should not be considered to be pro rata shares of a de facto Investment Company, rather than individual accounts at an IA.

The Rule 3a-4 guidelines can directly implicate Voting IAs in one or more ways. For example, many investors may be aware that their investment decisions are equivalent to endorsements, or non-endorsements, of a company's activities. If a client no longer agrees with a company's activities, they can either choose to sell their shares or engage with the Company in an effort to change their practice. By retaining voting authority and voting in line with the recommendations of proxy advisory firms, Voting IAs deprive their clients of an important lever to further their individual investment objectives.

In addition, IA client preferences are assumed when voting decisions are made on their behalf by Voting IAs. This means that clients do not have the ability to impose reasonable restrictions with respect to an important activity taken on their behalf by Voting IAs. Furthermore, the rule “retain rights of ownership . . . including the right to engage in shareholder votes,” itself calls out voting of securities as a “right of ownership.” However, Voting IAs that flatly retain this authority on behalf of their clients obviously do not allow them to retain this right of ownership.

Pass-Through Voting IAs provide voting materials directly to their clients so that they can vote their own shares. Generally, little to no effort is made by IAs to educate investors regarding their right to vote, and 70% of retail shareholders do not vote their shares at all.

Regulators are primarily concerned with ensuring that retail shareholders make informed voting decisions. An informed voting decision is generally described by regulators as one made after receipt of all communications presently required by law. While it is important for shareholders to receive these materials, receipt of proxy materials alone does not automatically qualify a vote as informed. An “informed” voting decision is instead one that is in line with a shareholder's beliefs.

Certain systems, devices, and methods described herein can be able to generate individual voting decisions for shareholders for each of the securities that they hold for which a vote or consent is solicited. In some embodiments, if shareholders also grant the system a proxy, the system can be able to then cast votes on their behalf at the applicable annual meeting.

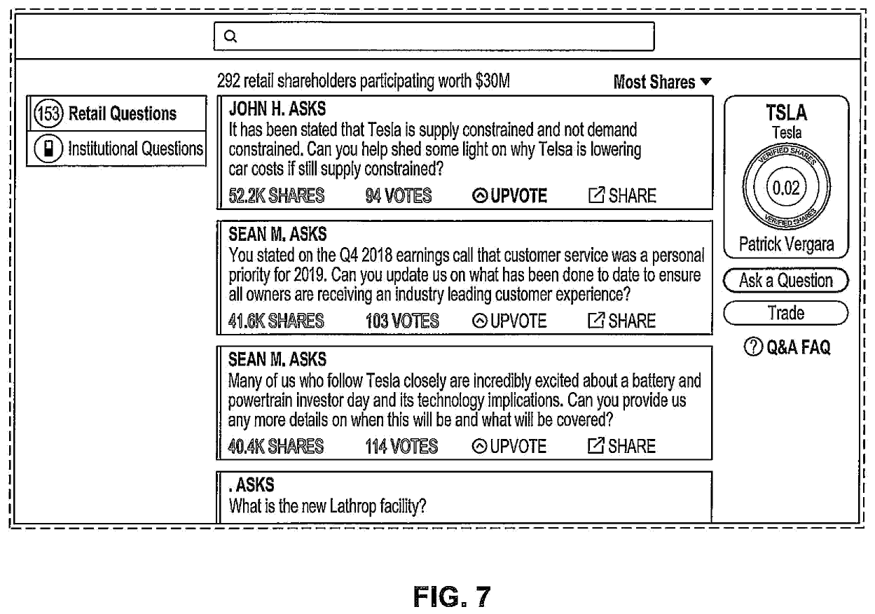

In some embodiments, the main server 150 and/or the computer system 202 may be configured to utilize a Q&A platform. FIG. 7 illustrates an example embodiment(s) of a Q&A platform of one or more embodiments of systems, devices, and methods for a data communications protocol platform. In some embodiments, the Q&A platform can authenticate share ownership and/or allow shareholders to ask questions to companies. In some embodiments, the system can be configured to authenticate shareholders and/or allow upvoting and sharing of questions with companies and/or other shareholders. As such, in some embodiments, the Q&A platform can generate data insights to contribute to creation of a metric(s).

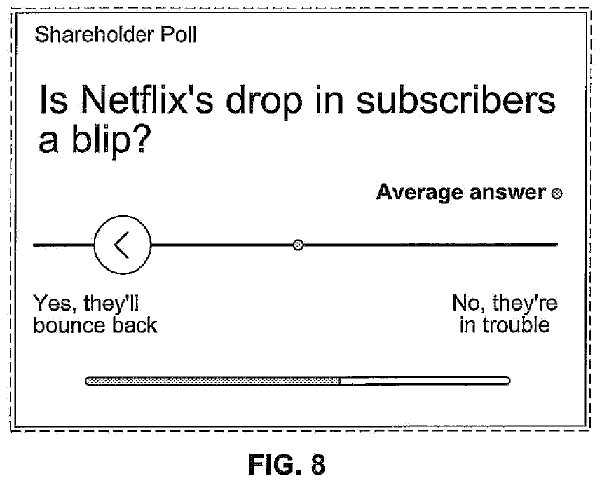

In some embodiments, the main server 150 and/or the computer system 202 may be configured to utilize a polling platform. FIG. 8 illustrates an example embodiment(s) of a polling platform of one or more embodiments of systems, devices, and methods for a data communications protocol platform. In some embodiments, the polling platform can allow companies and/or other entities to create dynamic polls for verified shareholder feedback. In some embodiments, polling questions can be updated in real time based on feedback from prior poll questions. As such, in some embodiments, the polling platform can be leveraged to generate data insights contributing to a metric(s). In some embodiments, shareholder responses can be cross-referenced against holdings and/or other basic metrics and/or sub-metrics to generate insights.

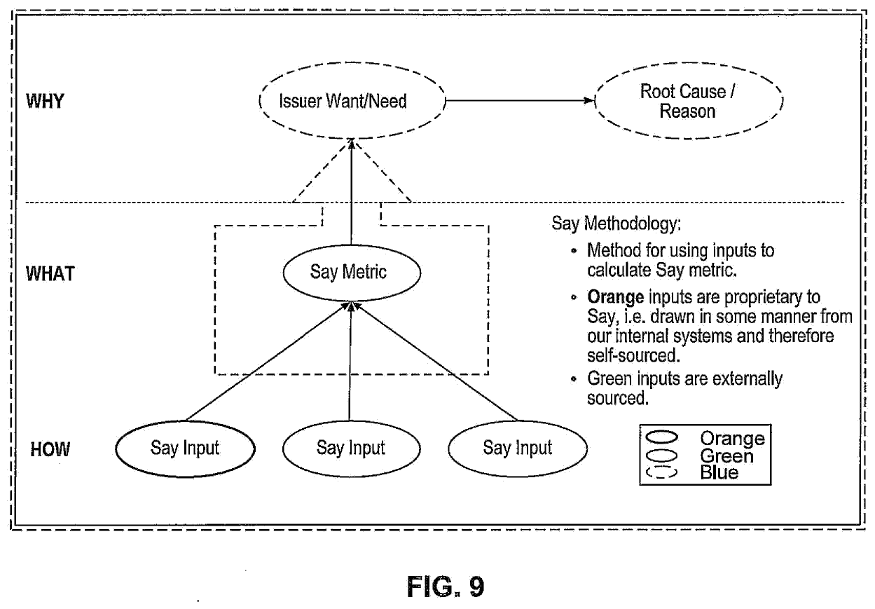

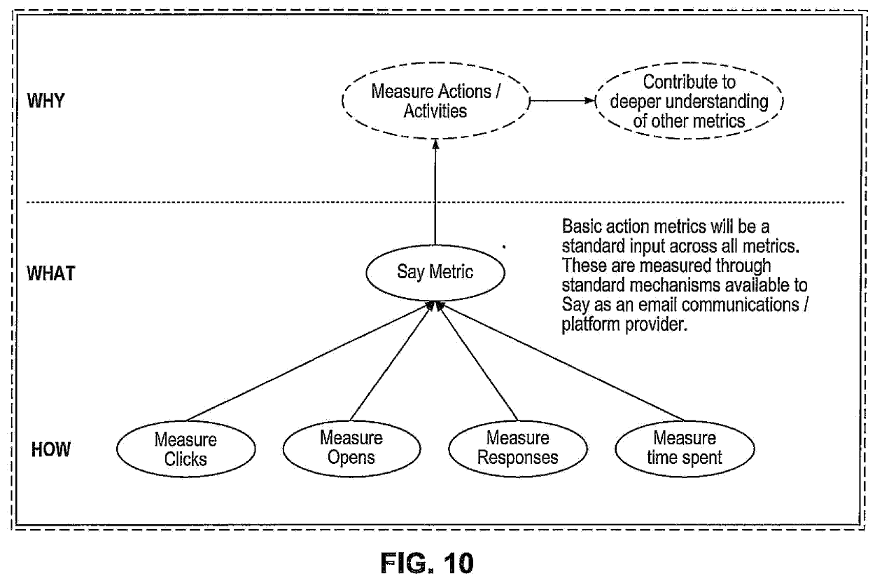

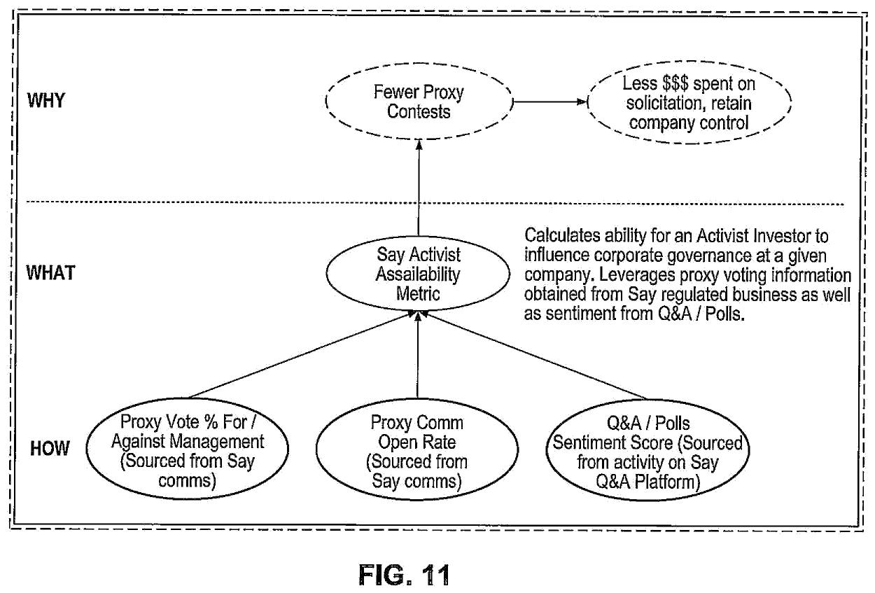

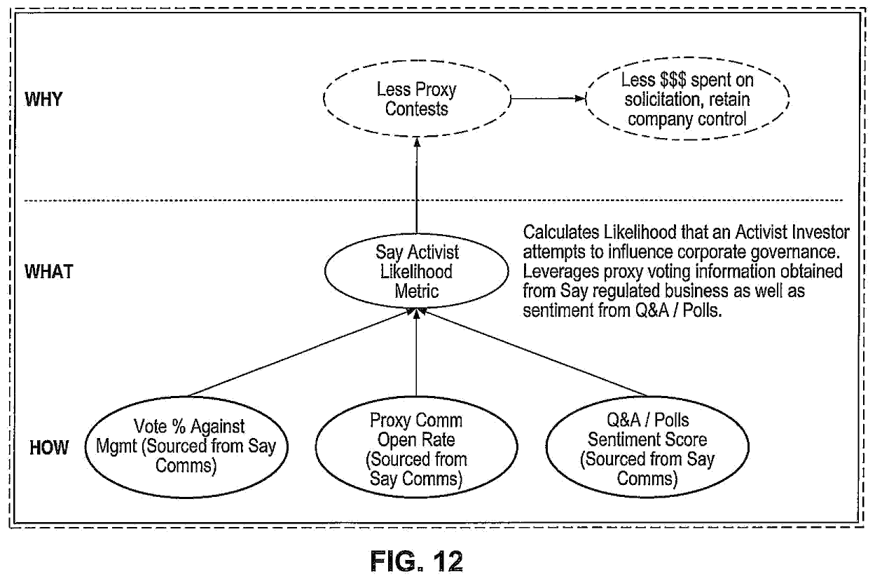

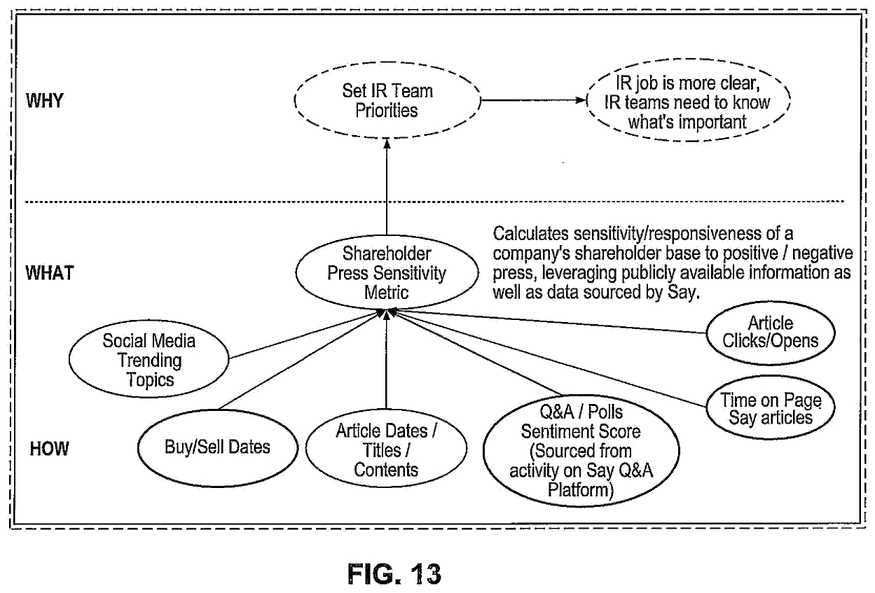

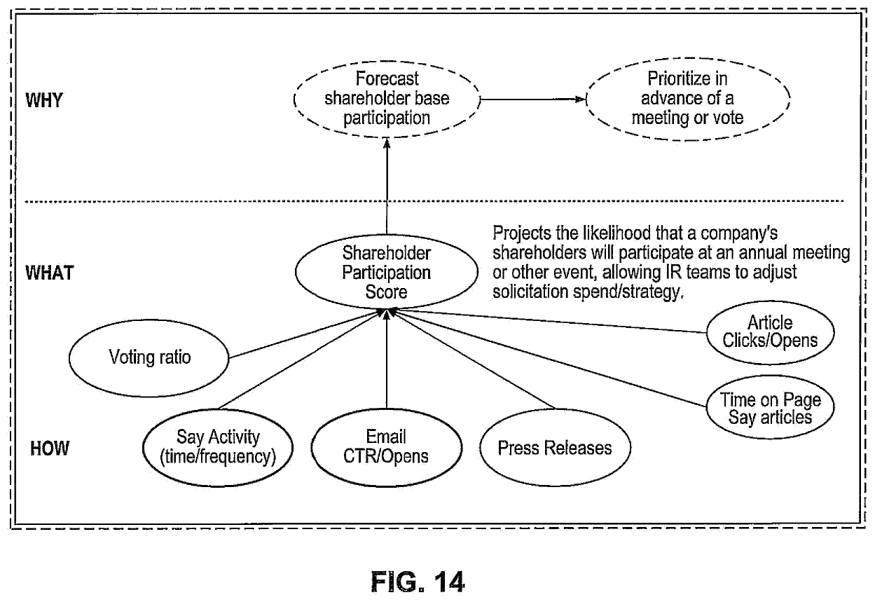

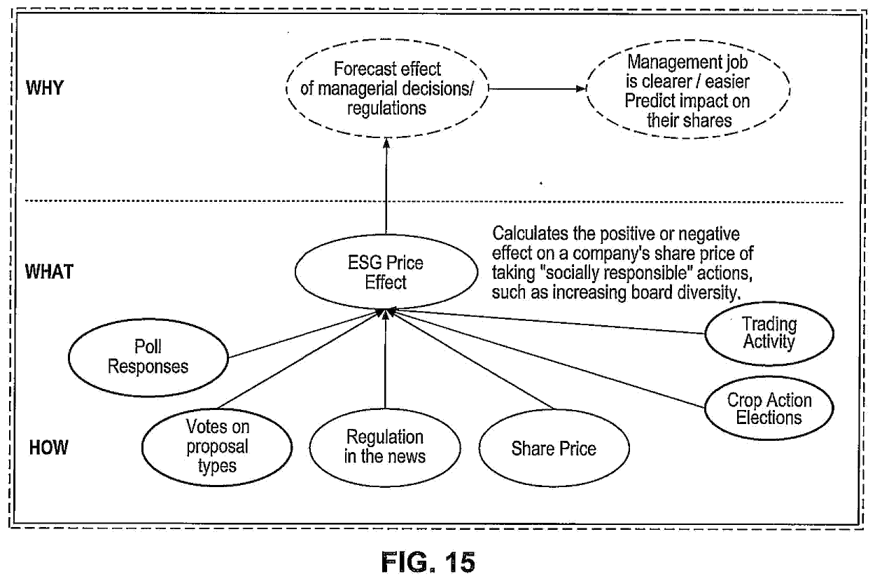

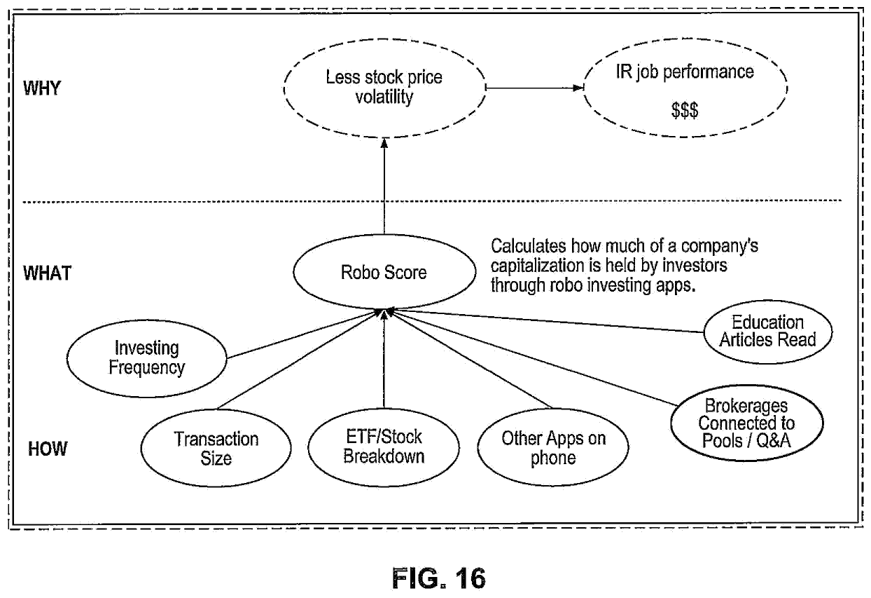

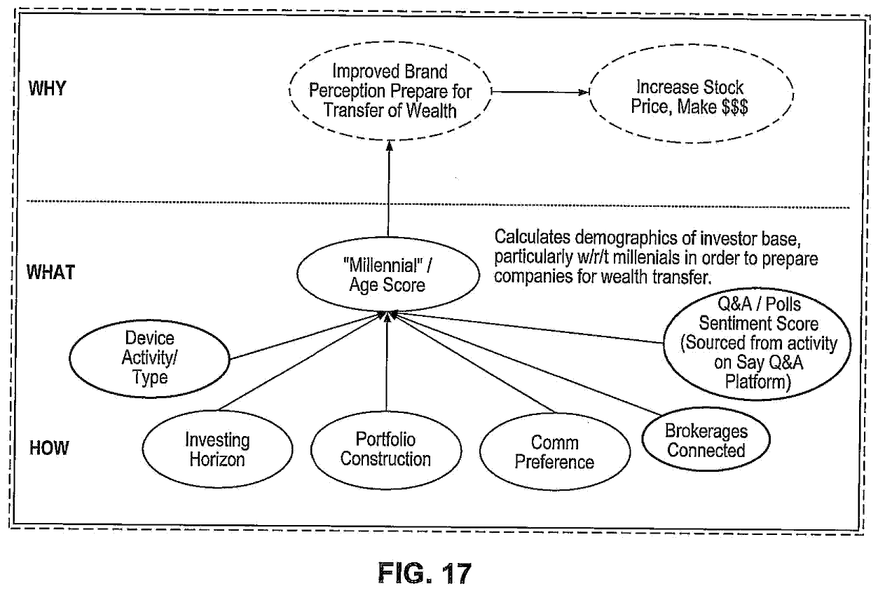

FIG. 9 is a schematic diagram illustrating features of a metric or score generation framework according to one or more embodiments of systems, devices, and methods for a data communications protocol platform, such as data communications protocol platform 214 in FIG. 2. FIG. 10 is a schematic diagram illustrating features of one or more basic action metrics or sub-metrics that can be utilized by one or more embodiments of systems, devices, and methods for a data communications protocol platform to generate a metric or score, or a subset of a score. FIG. 11 is a schematic diagram illustrating features of an activist assailability score that can be utilized by one or more embodiments of systems, devices, and methods for a data communications protocol platform to generate a metric or score. FIG. 12 is a schematic diagram illustrating features of an activist likelihood score that can be utilized by one or more embodiments of systems, devices, and methods for a data communications protocol platform to generate a metric or score. FIG. 13 is a schematic diagram illustrating features of share price/press reaction sensitivity that can be utilized by one or more embodiments of systems, devices, and methods for a data communications protocol platform to generate a metric or score. FIG. 14 is a schematic diagram illustrating features of a shareholder participation score that can be utilized by one or more embodiments of systems, devices, and methods for a data communications protocol platform to generate a metric or score. FIG. 15 is a schematic diagram illustrating features of an ESG price effect that can be utilized by one or more embodiments of systems, devices, and methods for a data communications protocol platform to generate a metric or score. FIG. 16 is a schematic diagram illustrating features of a robo score that can be utilized by one or more embodiments of systems, devices, and methods for a data communications protocol platform to generate a metric or score. FIG. 17 is a schematic diagram illustrating features of a millennial/age score that can be utilized by one or more embodiments of systems, devices, and methods for a data communications protocol platform to generate a metric or score.

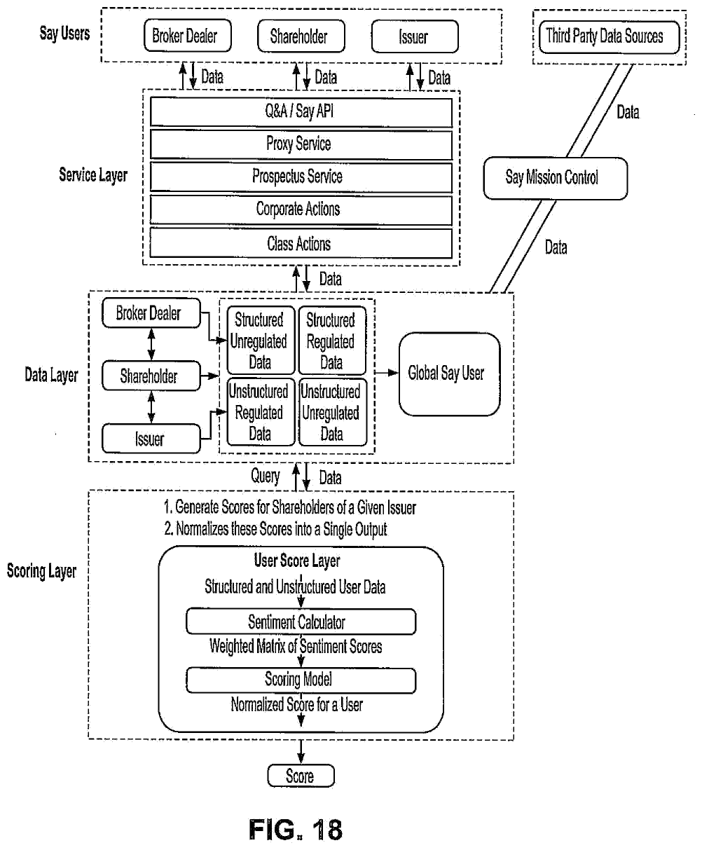

FIG. 18 is a schematic diagram illustrating features of one or more embodiments of systems, devices, and methods for a data communications protocol platform for generating one or more scores and/or metrics. In some embodiments, one or more of the entities identified as Say Users interact with products and services available to them, generating data. In some embodiments, the system can combine various datasets it obtains through the course of these activities in order to generate unique a unique score or scores. In some embodiments, the method for deriving a score can encompass machine learning techniques as well as standard algorithmic weighting. In some embodiments, such score(s) can predict behaviors and/or outcomes as they pertain to one or more of the three main user categories, broker-dealers, shareholders, and issuers.

As illustrated in FIG. 18, in some embodiments, the system can comprise a scoring layer, data layer, and/or service layer. The service layer can interact with one or more users, such as broker dealers, shareholders, and/or issuers. The service layer can provide and/or receive data from such one or more users. In some embodiments, the service layer can provide users access to a Q&A API, polls, proxy service, prospectus service, corporate action(s), and/or class action(s). In some embodiments, users can interact with the system or platform for their specific purpose by utilizing one or more services of the service layer. Through the course of users' interaction, the system can generate, access, and/or receive data, which can be used to generate a score(s).

In some embodiments, the Q&A API can provide a direct communication channel between companies and verified shareholders, which primarily captures unregulated data regarding shareholder sentiment. In some embodiments, through the proxy service, the system can sends all investor communications to shareholders at a partnered broker-dealer. In some embodiments, the system can facilitate voting for such shareholders when applicable. In some embodiments, through the prospectus feature, the system can send summary prospectuses to shareholders after purchase of a stock. In some embodiments, through the corporate action feature, the system can send notices of voluntary corporate action events to shareholders and allows them to provide their elections. In some embodiments, through the class action feature, the system can allow shareholders to obtain settlements due to them as a result of ownership of a security that is subject of a class action. In some embodiments, the system can work in partnership with a third party for any of the foregoing features, such as for example the class action feature.

In some embodiments, the Q&A, polls, and/or engagement API can be categorized as “consumer products,” whereas proxy, prospectus, corporate actions, and/or class actions can be categorized as “brokerage services.” In some embodiments, one or more consumer products and/or brokerage services can contribute unique data that can be used to generate a score(s) in the scoring layer.

In some embodiments, each category of user can have a different relationship with the system and can exchange different varieties of data, as illustrated in the tables below. The types of data listed in the tables below are not exhaustive and other types of data can be used in some embodiments. Additionally, in some embodiments, only a subset of the data listed in the tables below can be used.

TABLE 1
Consumer Products (Q&A/Polls/Say Engagement API)

| | Broker Dealer | Shareholder | Issuer |
|---|---|---|---|
| Nature of | Contractual relationship | User/platform | Contractual relationship |
| Relationship | between Broker Dealer | relationship between | between Issuer and Say, |
| to Say | and Say, Say provides | shareholder and Say, | Issuer agrees to interact |
| | API access for | opt-in to service. Can be | with shareholders on |
| | incorporation of Say | through broker-dealer if | Say platform |
| | consumer products on | BD has incorporated | |
| | BD App/Platform. | Say tools into platform, | |
| | | and can be through Say | |
| | | independently. | |
| Data | Positions Data | Shareholder | Issuer Sentiment |
| Provided to | Shareholder Data | Sentiment Data | Data |
| Say | | Shareholder Data | |
| Data | Data to power | Data produced | Data produced |
| Received | interface for | through interactions | through interactions |
| from Say | shareholders to | with issuer and other | with shareholders. |
| | interact with Issuers. | shareholders. | |

TABLE 2
Brokerage Services (Proxy, Prospectus, Corporate Actions, Class Actions)

| | Broker Dealer | Shareholder | Issuer |
|---|---|---|---|
| Nature of | Contractual relationship | As a customer of a | Provides information |
| Relationship | between Broker Dealer | broker dealer partnered | regarding upcoming |
| to Say | and Say, Say provides | with Say, receives | corporate events to Say |
| | Brokerage Services to | investor | through intermediaries. |
| | account holders. | communications. | |
| Data | Positions Data | Regulated | Regulated Issuer |
| Provided to | | Shareholder Data | Data |
| Say | | | |
| Data | Operational data | Shareholder | Votes |
| Received | | communications | |
| from Say | | | |

In the Tables 1 and 2, “positions data” can refer to information such as holdings, date of purchase, number of shares, and/or the like. “Shareholder data” can refer to contact information that allows communications to be routed to the correct shareholder. “Shareholder sentiment data” can refer to information about how a shareholder is feeling with respect to a given issue or inquiry, which may come in the form of an outright statement made on the platform, or more contextual information such as the time taken to respond on the platform. “Issuer sentiment data” can be a corollary to shareholder sentiment data and can represent an issuer's response and/or posture with respect to shareholder input. “Operational data” can refer to basic metrics to facilitate broker-dealer auditability and customer targeting.

In some embodiments, the system can receive data from third party sources to power one or more services and/or for feeding to the scoring layer. In some embodiments, such third party sources can include one or more broker dealers, shareholders, issuers, financial institutions, news media, financial analysis databases, and/or the like. In some embodiments, data received from a third party source can be related to shareholder events.

In some embodiments, certain data received, accessed, and/or analyzed by the service layer can be provided to and/or accessed by the data layer. In some embodiments, the data layer can also access and/or receive data from one or more third party data sources. In some embodiments, the data layer can be configured to collect the inputs obtained in the service layer and prepare them for use in the scoring layer. In some embodiments, the broker-dealer, shareholder, issuer and/or third party datasets are mapped upon one another in order to expand the scope and type of accessible data available for the scoring layer.

In some embodiments, data points with shared relevance that allows for behavioral insights can be indexed in such a way that they are easily available for manipulation in the scoring layer. In some embodiments, all data points can be associated with some user of the platform. As a non-limiting example, all information received in the course of providing consumer services to an issuer can be available for a given issuer alongside all information obtained for a given issuer in the course of providing all other services to all other customer types.

In some embodiments, data can be broken into four main categories: structured unregulated data, structured regulated data, unstructured regulated data, and unstructured unregulated data, as shown in Table 3. In some embodiments, it can be advantageous for the system to differentiate between regulated and unregulated data and associate information from each to a certain platform user.

As non-limiting examples, structured unregulated data can include number of upvotes on the Q&A platform, total dollar amount of shareholders participating, and/or the like. As non-limiting examples, structured regulated data can include number of votes on a proxy, issue meeting information, and/or the like. As non-limiting examples, unstructured regulated data can include proxy statement text, other disclosure and/or the like. As non-limiting examples, unstructured unregulated data can include shareholder questions on the Q&A platform, issuer responses to questions, and/or the like.

In some embodiments, the scoring layer is configured to generate a score or metric. In particular, in some embodiments, the scoring layer can be configured to process and manipulate data from the data layer and generate a score, which can be used to obtain a predictive or behavioral insight. In some embodiments, the scoring layer can output such a score for a given global user of the platform. In some embodiments, all data associated with a user or global user of the platform can be weighted and manipulated as required by the specific use case in order to obtain a given score.

As a non-limiting example, in some embodiments, an activist assailability score attempts to measure the ease with which an activist investor might be able to influence an issuer's behavior. The user or global user of the platform in this example can be the issuer for which the Activist Assailability Score is being generated.

In some embodiments, the system, or data layer thereof, can obtain one or more of the following inputs to produce or generate an activist assailability score, or any other score, having been mapped onto a particular user or global user of the platform. In some embodiments, these would then undergo a process in order to produce a normalized score for the user.

TABLE 3
Input sources handled by the data communications protocol platform in the system.

| Input | User Source | Data Category | Description |
|---|---|---|---|
| Q&A | Shareholder | Unregulated, | Sentiment is gathered via NLP sentiment |
| Question | | Unstructured | analysis. Sentiment is scored on a gradient as |
| Asked | | Data | either positive or negative based on the |
| | | | frequency of certain keywords in shareholder |
| | | | responses. |
| | | | This sentiment score can be measured in |
| | | | several ways, including: |
| | | | Weighted against average sentiment in a |
| | | | given Q&A |
| | | | Weighted against average sentiment in all |
| | | | past and present Q&As |
| | | | Weighted against average sentiment of a |
| | | | single user in Q&As not tied to a specific |
| | | | security (this would give their sentiment |
| | | | that security vs. others that they hold) |
| Q&A | Shareholder | Unregulated | Similar to above, but: |
| Question | | | The data set will be larger and structured |
| Upvoted | | | (more upvotes than questions asked) |
| | | | The score will have less weight compared |
| | | | to the act of asking a question due to a few |
| | | | reasons: |
| | | | 1. The question at hand may be a relevant |
| | | | question, but the author's tone was not a |
| | | | factor when a user upvoted |
| | | | 2. There is no limit on the number of |
| | | | questions a user can upvote currently |
| Survey | Issuer | Unregulated, | Sentiment can be calculated at survey |
| Responses | | Structured Data | creation time based on specific poll |
| | | | question text and possible answers |
| | | | Weighted against historical survey |
| | | | response sentiment |
| | | | Weighted against overall survey response |
| Survey | Issuer | Unregulated, | Questions asked |
| Question | | Unstructured | |
| Created | | Data | |
| Q&A | Issuer | Unregulated, | Length of answer |
| Issuer | | Unstructured | Questions answered |
| Response | | Data | Sentiment of answer |
| Holdings | Broker Dealer | Regulated, | Age of holding |
| Data | | Structured Data | Quantity of holding |
| | | | Compared to average across all users at |
| | | | a given brokerage |
| | | | Compared to average across all users at |
| | | | all brokerages |
| | | | Compared to other holdings in a user's |
| | | | portfolio |
| Proxy | Broker | Regulated | Previous vote history |
| Vote | Dealer; | Structured Data | For or against board recommendation |
| Results | Shareholder | | Shareholder v. Management proposal |
| | | | Voting options presented |
| | | | Overall vote |
| | | | Changed votes |
| | | | Proposal category |
| Trading | Broker | Regulated, | Increasing share count |
| Activity | Dealer; | Structured Data | Decreasing share count |
| | Shareholder | | Weighted against security price moving |
| | | | up or down |
| | | | Weighted against market moving up or |
| | | | down. |

Platform Scoring—Additional Detail/Features

In some embodiments, as discussed above, the system can be configured to produce or generate one or more top-level scores. In some embodiments, in order to generate the score, the system can be configured to combine different inputs and/or assigning a weight to each input. As a non-limiting example, the system can be configured to generate an activist risk score. In some embodiments, the activist risk score can comprise two sub-scores. In some embodiments, each sub-score, or at least some of the sub-scores, can comprise six inputs, which draw on one or more sources of data available to the platform. In some embodiments, one or more inputs, sub-scores, and/or other data can be combined according to specific algorithms and/or techniques calibrated for each metric.

As discussed above, in some embodiments, the system platform can provide connection points between different entities, through one or more platform products, services, features, or otherwise. In some embodiments, such connection points can be combined in order to generate data insights. In some embodiments, the different entities can comprise broker dealers, shareholders, and/or companies. Each of these entities can access and/or be connected to the platform via one or more brokerage products, Q&A platform, and/or polling platform. In some embodiments, the system can be configured to enhance such proprietary data by utilizing data from one or more public data sources.

As discussed above, in some embodiments, the system can be configured to generate or produce an activist risk score in addition to other scores. In some embodiments, the system can be configured in real time to produce novel scores, or scores can be selected from a preset list. In some embodiments, an activist risk score can refer to a top-level score that measures the likelihood that a company will become the target of a successful activist shareholder campaign. In some embodiments, a “successful” campaign can be defined as one that results in the company needing to take a concrete action (i.e. removing a director) in response to the requests of an activist shareholder.

In some embodiments, an activist risk score is a composite score comprised of two sub-scores: (i) an activist likelihood score, and (ii) an activist assailability score. In some embodiments, each of these sub-scores is in turn comprised of one or more primary inputs, which are weighted according to one or more predetermined algorithms. In some embodiments, these primary inputs are sourced from products or services available via the service layer.

In some embodiments, an activist likelihood score or sub-score can measure a likelihood that an activist investor will engage in a campaign to influence company behavior. In some embodiments, an activist likelihood score or sub-score can track shareholder sentiment and/or company performance. Some non-limiting examples of primary inputs for generating an activist likelihood sub-score can include company-specific Q&A sentiment, comparable company Q&A sentiment, and/or company performance. Company-specific Q&A sentiment can include one or more non-quantitative sentiments and/or quantitative sentiments. Comparable company Q&A sentiment can include one or more non-quantitative sentiments and/or quantitative sentiments. Company performance can include financial and/or stock performance, and/or investor behavior.

In some embodiments, an activist assailability score or sub-score can measure how susceptible a company is to shareholder activism, i.e. likelihood that an activist would succeed in effecting its desired change at a company. In some embodiments, an activist assailability score or sub-score can track composition and regulated voting behavior of shareholder base, including known activists on cap table. Some non-limiting examples of primary inputs for generating an activist assailability sub-score can include results of proxy votes, shareholder base composition, and/or comparable company results and composition. Results of proxy votes can include shareholder proposals and/or other proposals. Shareholder base composition can include institutional composition and/or retail composition. Comparable company results and composition can include results of proxy votes and/or shareholder base composition.

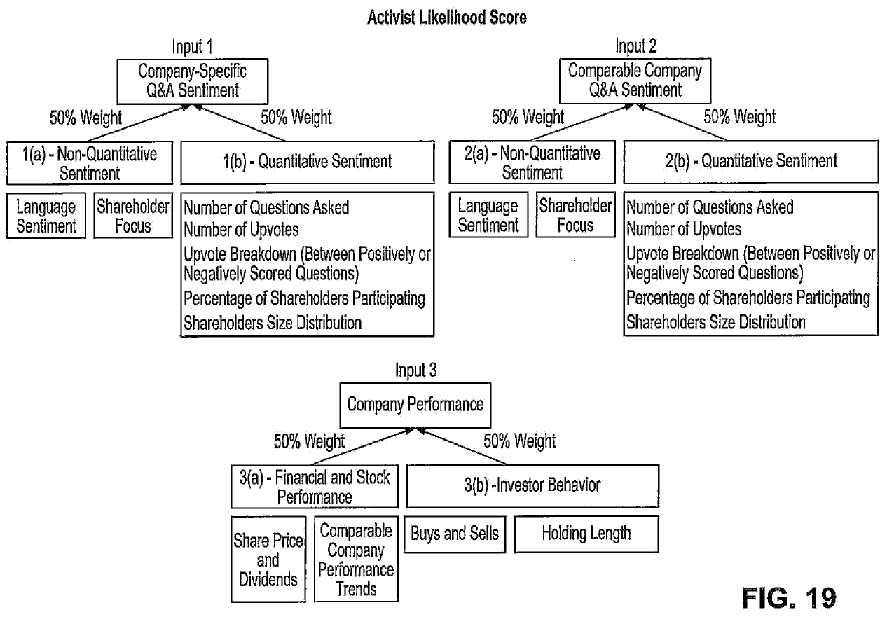

FIG. 19 is a schematic diagram illustrating features of one or more embodiments for generating an activist likelihood score according to one or more embodiments of systems, devices, and methods for a data communications protocol platform. As discussed above, in some embodiments, the activist likelihood score is one of two sub-scores used to create the activist risk score. In some embodiments, an activist likelihood score can be weighted 50% in generating the activist risk score. As non-limiting examples, inputs for determining an activist likelihood sub-score can include company-specific Q&A sentiment, comparable company Q&A sentiment, and/or company performance. In some embodiments, one or more of these inputs can be obtained from the service layer and stored in the data layer, which can be weighted and combined according to one or more scoring algorithms.

In particular, in some embodiments, an input for generating an activist likelihood score can include non-quantitative company-specific Q&A sentiment. In some embodiments, this input is comprised of results of Q&As where only company shareholders participated. In some embodiments, it comprises a language-driven approach that attempts to capture how shareholders are feeling about a given company based on the tone, content and/or orientation of the questions they are asking. In some embodiments, it is in turn broken into two granular inputs, Language Sentiment and Shareholder Focus. In some embodiments, non-quantitative company-specific Q&A sentiment is sourced from the system's Q&A platform and can be provided a company's direct and/or indirect shareholders who create accounts and/or authenticate ownership through the Q&A platform.

In some embodiments, an input for non-quantitative company-specific Q&A sentiment can include language sentiment. More specifically, in some embodiments, the system can analyzes words used in questions asked by shareholders across two parameters: (i) sentiment, and (ii) shareholder focus. In some embodiments, sentiment is measured by analyzing a selection of words in all shareholder questions and tagging them automatically with “positive” (i.e. a word like “great”), “neutral” (i.e. a word like “iPhone”) or “negative” (i.e. a word like “falling”). In some embodiments, an input for non-quantitative company-specific Q&A sentiment can include shareholder focus. In some embodiments, shareholder focus is measured by categorizing shareholder questions across one of four question categories (i.e. Product, Operations, Governance, Other), and correlating with language sentiment in order to produce either positive or negative scores for each of the focus areas.

In some embodiments, an input for generating an activist likelihood score can include quantitative company-specific Q&A sentiment. In some embodiments, quantitative company-specific Q&A sentiment can represent the quantitative side to shareholder sentiment, focusing on engagement metrics that can be gathered from the Q&A Platform. In some embodiments, quantitative company-specific Q&A sentiment can be provided by direct and/or indirect company shareholders who create accounts and authenticate ownership through the Q&A platform.

In some embodiments, an input for quantitative company-specific Q&A sentiment can be obtained from analyzing one or more quantitative metrics associated with a Q&A campaign. For example, this can include the number of questions asked by shareholders participating in a Q&A campaign, which can track shareholder attention to the company. In addition, such quantitative metrics can also include the gross number of upvotes received, which can track shareholder engagement on a general level. Quantitative metrics can also include the upvote breakdown between positively and negatively scored questions. In other words, the system can, in some embodiments, measure upvotes across questions with a positive or negative sentiment score, which can track shareholder sentiment based on reactions to other shareholder questions. Quantitative metrics can also include percentage of eligible shareholders participating, which can track shareholder interest on a general level. Quantitative metrics can also include shareholder size distribution or measuring the holding size of shareholders participating in a Q&A in order to understand interest amongst large v. small shareholders. This can tracks sentiment breakdown between retail, large and institutional shareholders.

In some embodiments, an input for generating an activist likelihood score can include non-quantitative and/or quantitative comparable company Q&A sentiment. The sources and/or inputs of non-quantitative and/or quantitative comparable company Q&A sentiment can include one or more sources and/or inputs as discussed above in relation to company-specific Q&A sentiment but for a company with a similar profile as the company in question.

In some embodiments, an input for generating an activist likelihood score can include company performance, such financial and stock performance, and in particular share price and dividends. More specifically, in some embodiments, performance of a given company's stock, primarily in terms of price and/or dividend payments, can be sourced from one or more publicly available sources, such as EDGAR and/or subscription data feeds. Share price and dividends can represents a company's share performance, specifically 12 month rolling share price and/or dividend payments for example.

In some embodiments, an input for generating an activist likelihood score can include company performance, such financial and stock performance, and in particular comparable company performance trends. Performance of comparable companies' stock can provide a gauge of how a given company is performing relative to its peers. Such input can be sourced from one or more publicly available sources, such as EDGAR and/or subscription data feeds. In some embodiments, comparable company performance trends can represent performance of comparable companies along the same parameters, for example 12 month rolling share price and dividend payments. As a non-limiting example, comparable companies for a company like Apple can include mega-caps, tech companies and other Dow Jones companies.

In some embodiments, an input for generating an activist likelihood score may include company performance, such investor behavior, and in particular buys and sells. More specifically, the system can receive input relating to investor behavior with respect to a given stock, namely the ratio of buys and sells, from the system or platform's brokerage products or features. In some embodiments, the system or platform's connection to brokerages can allow the system to identify whether shareholders are buying/selling shares of a company's stock. The ratio of sales to purchases can be used as a gauge of shareholder satisfaction.

In some embodiments, an input for generating an activist likelihood score can include company performance, such investor behavior, and in particular holding length. More specifically, the system can receive input relating to investor behavior specifically as it correlates to holding length—i.e. whether investors remain invested in a stock over a long period of time. Such input or data can be received or accessed from the system or platform's brokerage products or features. In some embodiments, the system or platform's connection to brokerages can allow the system to see how long investors have held shares of a given stock for through access to settlement date information. In some embodiments, the system can also determine if they have upsized or downsized their position in a stock over time.

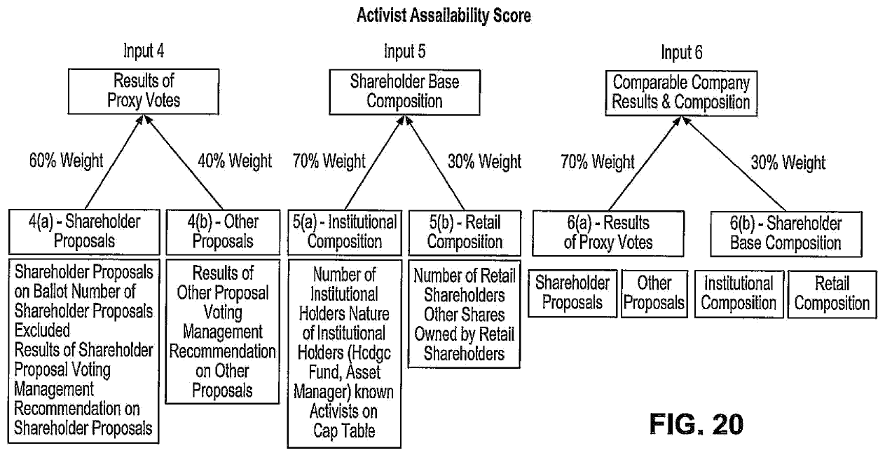

FIG. 20 is a schematic diagram illustrating features of one or more embodiments for generating an activist assailability score according to one or more embodiments of systems, devices, and methods for a data communications protocol platform. As discussed above, in some embodiments, the activist assailability score is one of two sub-scores used to create the activist risk score. In some embodiments, an activist assailability score can be weighted 50% in generating the activist risk score. As non-limiting examples, inputs for determining an activist assailability sub-score can include results of proxy votes, shareholder base composition, and/or comparable company results and composition. In some embodiments, one or more of these inputs can be obtained from the service layer and stored in the data layer, which can be weighted and combined according to one or more scoring algorithms.

In particular, in some embodiments, an input for generating an activist assailability score can include results of proxy votes, for example for shareholder proposals and/or other proposals. More specifically, in some embodiments, the system can be configured to track results of one or more prior proxy votes of the company of interest. Such data can be sourced from the system and/or platform's brokerage operation products and/or features. In some embodiments, the system can be configured to receive, access, and/or analyze results of votes on proposals submitted by shareholders, which can be used to gauge levels of shareholder activist sentiment, particularly amongst retail shareholders, and willingness of shareholders to support dissenting views. In some embodiments, the system can be configured to receive, access, and/or analyze results of votes on all non-shareholder proposals (i.e. management proposals), which can be used to track levels of shareholder alignment with company management under ordinary circumstances.

In some embodiments, an input for generating an activist assailability score can include shareholder base composition, for example institutional composition and/or retail composition. Shareholder base composition can be used to track the composition of a company's shareholder base, such as for example institutional ownership, retail ownership, and/or the like. Such data can be sourced from public filings and/or the system or platform's brokerage operation products or features, Q&A, or other products. In some embodiments, information regarding institutional ownership of public companies can be scraped from EDGAR. In some embodiments, in order to analyze retail composition, the system can obtain information regarding a company's shareholders when they create an account in order to participate in a Q&A.

In some embodiments, an input for generating an activist assailability score can include comparable company voting results and/or shareholder base composition. In particular, in some embodiments, the system can track results of prior proxy votes and shareholder base composition for similarly situated companies. For example, for Apple, as a non-limiting example of a company that might serve as an end user for such a score, comparable companies can include mega-cap companies, software companies or technology device companies. Such data can be sourced from public filings and/or the system or platform's brokerage operation products or features, Q&A, or other products. In some embodiments, data on comparable company voting results and/or shareholder base composition can include unregulated structured data and/or regulated structured data. Inputs for data on comparable company voting results and/or shareholder base composition can include any of the inputs discussed above in relation to the company of interest.

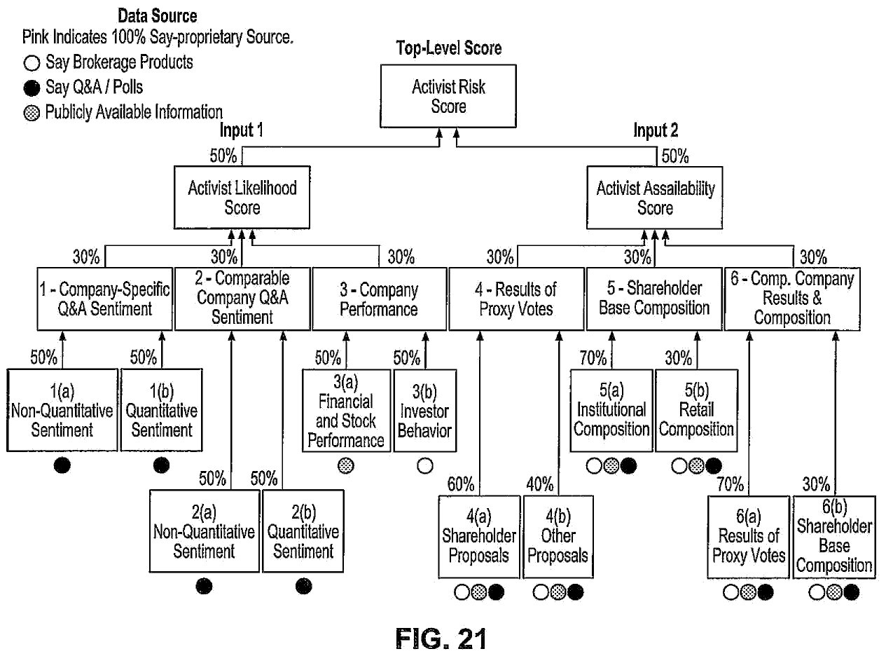

FIG. 21 is a schematic diagram illustrating features of one or more embodiments for generating an activist risk score according to one or more embodiments of systems, devices, and methods for a data communications protocol platform. As illustrated in FIG. 21, in some embodiments, the system or platform is configured to combine and/or integrate one or more inputs and/or sub-scores, for example by giving each input or sub-score a particular weight or the like. In some embodiments, the system or platform can be configured to utilize and/or analyze one or more of the inputs or sub-scores as-is isolation, without combining with another sub-score or input.

In some embodiments, some of the inputs and/or sub-scores, such as financial and stock performance, can be assigned a numerical score, for example on a scale of one to ten. In some embodiments, some of the inputs and/or sub-scores, such as a non-quantitative sentiment, can be assigned a vector, for example good, bad, or neutral. In some embodiments, some inputs and/or sub-scores, such as comparable company performance, can be assigned a binary score, such as yes or no.

In some embodiments, some of the inputs and/or data for determining a score or sub-score can comprise proprietary data that is sourced directly from company-specific stakeholders on the platform. For example, in some embodiments, such input and/or data can be obtained through Q&A and/or polling features of the platform directly from company shareholders. In some embodiments, such proprietary data can be combined with publicly available data or information. In some embodiments, the system can be configured to monitor all or some shareholder communications on the platform to automatically and/or dynamically collect, analyze, and/or identify one or more such inputs from the shareholder communications. In some embodiments, such capabilities are possible as the platform can comprise both shareholder communications features, such as the Q&A and/or polling features, as well as a scoring platform for generating a company-specific score(s). By analyzing shareholder communications, in some embodiments, the system is capable of utilizing information relating to the sentiment, sensitivity, or feeling of a shareholder in generating a score.

In some embodiments, the system or platform can be configured to utilize artificial intelligence (AI) and/or machine learning to automatically and/or dynamically generate a company-specific score(s) based on one or more inputs. In some embodiments, the particular algorithm, technique, or process of generating a score by combining one or more inputs can evolve over time, rather than remaining static. For example, in some embodiments, the system can turn on or off a particular input or sub-score depending on the situation. Further, in some embodiments, the system can emphasize or deemphasize or ignore a particular input or sub-score depending on the situation.

In some embodiments, the system can be configured to dynamically and/or automatically provide additional options, action items, or the like to a user based on the generated score. For example, depending on the resulting company-specific score, the system can be configured to dynamically generate certain icons, buttons, or options for the user to take on the user interface. In some embodiments, users may be prompted to send a communication through regulated proxy channels, initiate a poll and/or conduct a Q&A with shareholders. Some options or icons can appear only when the generated company score is above, below, at, or within a particular score or range of scores.

More specifically, in some embodiments, if the generated activist risk score for a particular company is high or above a particular threshold level, the system can be configured to dynamically and/or automatically provide or suggest certain options, action items, or the like to the user. For example, in some embodiments, if the generated activist risk score for a particular company is above a predetermined threshold, the system may suggest or facilitate a certain corporation action(s) to the user, by opening a new window for taking such action on the user interface, displaying or highlighting such option on the user interface, generating electronic communications, or the like. Some of such options or action items may include corporate actions, such as offering a dividend, stock split, or the like. In addition, in some embodiments, the system can automatically and/or dynamically suggest sending some communication out to the shareholders either through regulated or unregulated channels, issuing a press release, sending out a poll to the company shareholders, or the like. In other words, in some embodiments, depending on the generated score, the system can be configured to automatically and/or dynamically present options or actions to take to the user and facilitate the same.

In some embodiments, the system can be configured to continue to generate and track the score of a company after the company takes some action in response to a generated score. For example, in some embodiments, the system can track to determine whether the company's score has improved, not changed, or worsened as a result of taking some action. Based on such tracking data, in some embodiments, action items and/or options suggested by the system can also evolve as the system learns from previous data.

Personally Identifiable Information (PII)

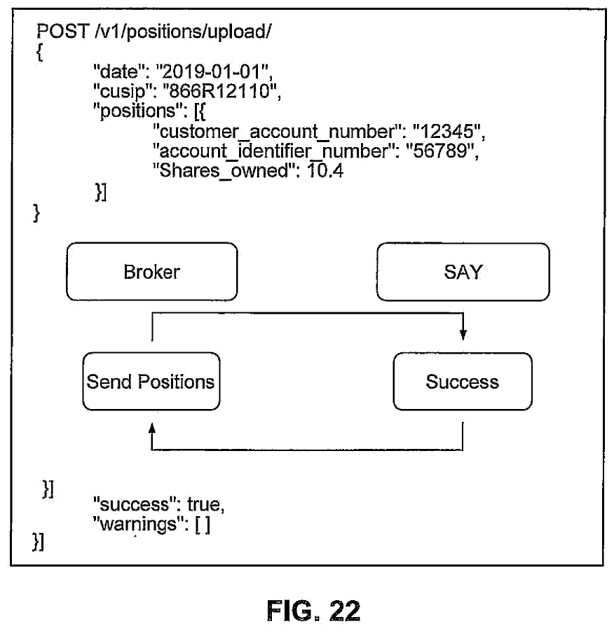

FIG. 22 is a schematic diagram illustrating features of one or more embodiments of protecting personally identifiable information (PII) according to one or more embodiments of systems, devices, and methods for a data communications protocol platform. In some embodiments, the system or platform integrates with broker dealer systems such that the platform or system does not store any personal information of the broker dealer's customers. In particular, in some embodiments, rather than sending information directly to shareholders, the platform or system instead only provides such information to broker dealers who are known to have customers who are shareholders of a certain company, at which point the broker dealer can send out the information itself to its shareholder customers. In other words, in some embodiments, the platform or system only has access to data relating to which broker dealer has customers who are shareholders of a particular company, without having access to any personal information about a customer.

URLs and Cookies

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Doman Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

Token Voting System

In some embodiments, the system can be configured to provide voting services for trustless trading platforms, such as distributed ledger technology-based systems or the like. In other words, in some embodiments, the system can provide a trustless public record of voting instructions. In particular, in some embodiments, voters who connect to the platform and vote can be provided tokens representing (i) their voting interest, and (ii) how they have voted or how they are committing to vote through the pre-existing proxy plumbing or on a Say Proposal.

In some embodiments, upon signing up for the platform, an investor can provide the system with access to their holdings. The system can be configured to use this information to create a token, which represents the investor's voting interest (“Token 1”). Token 1 can represent the investor's identity and voting power with respect to a certain company. It can be used to vote on a proxy item or pledge support to an informal proposal, or be transferred or pledged to a third party to be voted in accordance with their wishes. In some embodiments, Token 1 is tied to the investor's holdings as tracked by the system, including share price fluctuations. Token 1 can continue to exist after the vote is cast.

In some embodiments, when a shareholder votes, a one-time token (“Token 2”) is generated based on Token 1 and the shareholder's voting instructions. Token 2 can be a static, credible record of how a shareholder voted (an “I Voted” sticker or ink-dipped finger). In some embodiments, it is possible that some meeting-specific inputs (i.e., a hash of the proxy statement as uploaded to EDGAR) would be associated with Token 2 in order to make it vote specific. When Token 2 is generated, it can be tagged to the Token 1 holdings that existed at the time Token 2 was generated. In some embodiments, Token 2 cannot be generated past the voting deadline.

In some embodiments, Token 2 tags the identify of a voter to their voting decision. In the event a vote is changed, a new Token 2 can be created that points to the first Token 2, such that an infinite chain of Token 2s could be created, but only the last one in the chain is the vote that counts. This can open a possible attack vector for the malicious creation of nearly infinite chains of tokens to starve resources. In some embodiments, this could be mitigated by utilizing a breadth-first analysis of the votes until a majority arises. For example, the system can be configured to pull all tier 1 votes and tier 2 votes, and sum all tier 1 votes that were not voided. The system can further be configured to pull all tier 3 votes if there's no clear winner yet, and sum all tier 1 plus rejected 1s replaced by 2s that do not have tier 3. If no majority, the system can be configured to proceed to the next tier of revoked votes. Alternatively or in addition to the above, in some embodiments, the system can be configured to cap the number of allowable vote changes. For example, a user can change votes at most once every 10 minutes in some embodiments.

As such, in some embodiments, the system can be configured to utilize a token system as described above. A token system can be beneficial by formalizing the “informal” or by giving structure to the system as a formal, stable, alternative plumbing system. A token system can be further advantageous as Token 1 can create an opportunity for a transferable voting interest, and perhaps even a new market. Further, in some embodiments, Token 2 is a credible, live, public record of voting returns. Furthermore, the system can provide a structure for a new way to quantify ownership that may be detached from number of shares or dollar value.

Cross-Broker Authentication

Generally, shareholders can have investments through multiple broker-dealers. For example, someone may have a workplace 401(k) retirement account through Fidelity, a previous 401(k) at Charles Schwab rolled over into a Tradtional IRA, and a day trading account through Robinhood. In the traditional shareholder voting world, the shareholder may receive up to three distinct sets of voting instructions for any given vote if they have the same investments in all three brokerage accounts. In contrast, in some embodiments disclosed herein, the shareholder is able to authenticate an unlimited number of accounts at any broker-dealers partnered with the system.

More specifically, in some embodiments, a shareholder can register for their free account on the system using a first email address. Further, in some embodiments, a shareholder can receive one or more communications at a second email address from the system on behalf of their brokerages that the system has partnered with. In some embodiments, if the first email address and the second email address are identical, the system can be configured to send a confirmation email to the customer to confirm the account link between user account on the system and the broker-dealer. If unconfirmed, in some embodiments, the system can allow a user to re-initiate the link from a uniquely identifiable link in all communications sent to them. In some embodiments, future communications, such as votes and/or shareholder materials, can be delivered to the shareholder's user account on the system. The above processes do not have to be completed in any particular order in some embodiments.

In some embodiments, the system can be configured to allow a user to access, for example via a user account on the system, voting across any or all types of equities, across any or all system-partnered broker-dealers. In some embodiments, the system can be configured to provide access to and/or information regarding voting record of past votes and/or upcoming votes and deadlines. Further, in some embodiments, the system can be configured to provide streamlined voting across different broker-dealers. As an illustrative example, if a user owns GE in two accounts, the user may opt to vote both ballots simultaneously, or may opt to split their vote accordingly.

In some embodiments, the system can be configured to provide access to a user to collected shareholder materials, such as annual reports and prospectuses. In some embodiments, the system can be configured to provide access to such materials without any time limit and/or access limitations. In some embodiments, the system can be configured to provide access to communication preferences to a user. In some embodiments, the system can be configured to provide an authenticated connection(s) to one or more system-partnered brokerage applications, with the option to receive communications and votes through their existing brokerage smart phone application.

Voter Authentication

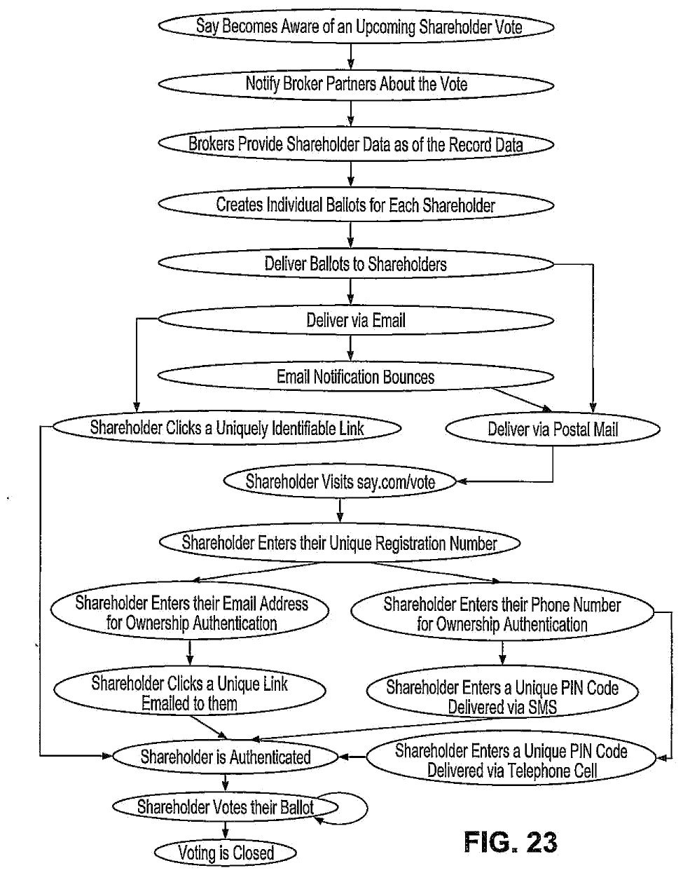

FIG. 23 is a flowchart illustrating a process for voter authentication according to an embodiment of the present disclosure. In particular, the system can be configured to perform one or more steps or processes to authenticate that a person is a valid shareholder and is eligible to vote. It can be important to balance usability, accessibility, and security. In other words, while important to ensure that everyone is a valid voter, it can also be equally important not to make the process so arduous that no one can effectively authenticate or vote.

More specifically, in some embodiments, the system can be configured to receive a list of beneficial shareholders related to a vote from one or more system-partnered broker-dealers. In some embodiments, the system can be configured to communicate the vote to the shareholders through various media, such as e-mail and/or postal mail, dependent on shareholder communication preferences for example. In some embodiments, the shareholder can authenticate via email, SMS, and/or phone. Once validated, in some embodiments, the shareholder can be allowed to vote. In some embodiments, the system can be configured to allow a shareholder to revise their vote up until the end of the voting period.

Point-In-Time Voting

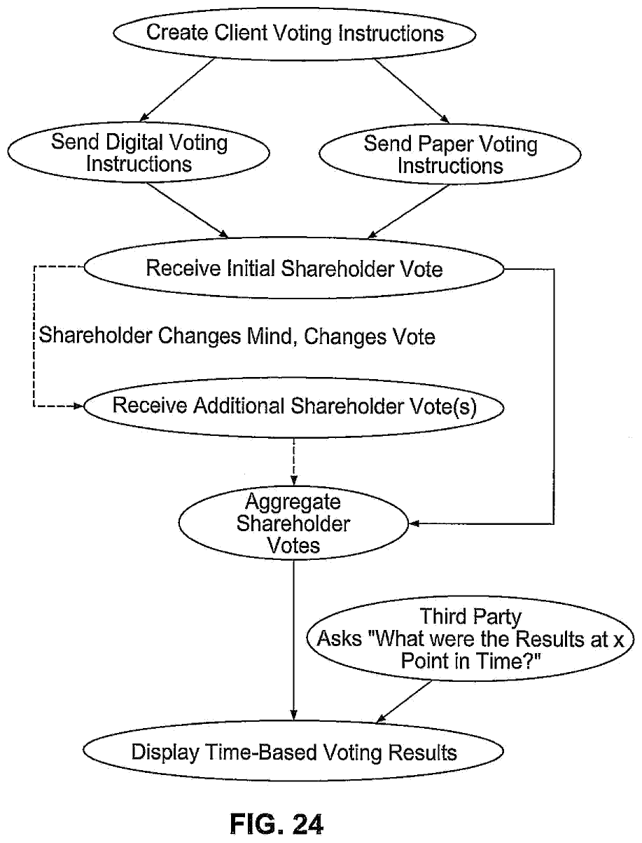

FIG. 24 is a flowchart illustrating a process of point-in-time voting according to an embodiment of the present disclosure. Here, the system is configured to provide third parties with access to point-in-time voting. More specifically, in some embodiments, the system can be configured such that a third party may see the current results of the vote as well as the results of the vote at any point in time. As such, questions such as “What did the results of the vote look like at 12:00 pm EST on 1/1/2018?” can be answered using the system in some embodiments.

In particular, in some embodiments, the system can be configured to create shareholder voting instructions. In some embodiments, digital and/or paper voting instructions can be sent out by the system based on shareholder preference. As votes are cast, in some embodiments, the system can be configured to continuously aggregate the results based on when the votes were cast. In some embodiments, third parties with access to the system can query the Application Programming Interface (API) to get results of a vote at any point in time.

Real Time Voting

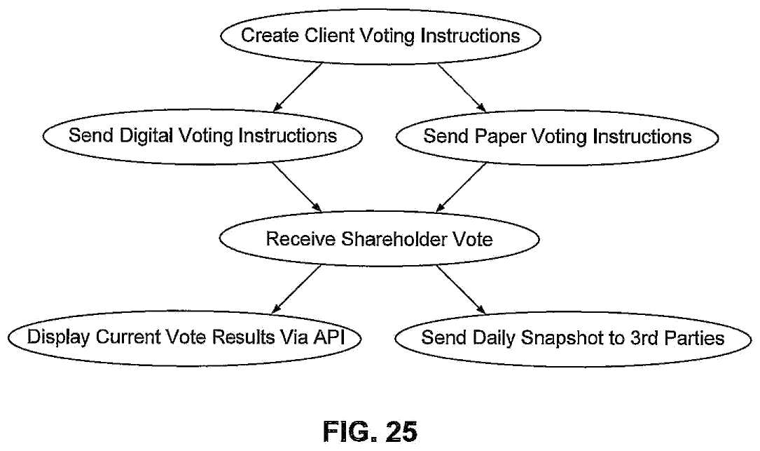

FIG. 25 is a flowchart illustrating a process of real time voting according to an embodiment of the present disclosure. In some embodiments, the system is configured to provide third parties with access to real time voting data as votes are collected from shareholders digitally and/or via paper. More specifically, in some embodiments, the system can be configured to create shareholder voting instructions. In some embodiments, the system can be configured to send out digital and/or paper voting instructions based on shareholder preferences. As votes are cast, in some embodiments, the system can be configured to continuously aggregate the results. In some embodiments, third parties with access to the system can retrieve the up-to-the-second voting results via an Application Programming Interface (API). In some embodiments, the system can be configured to provide daily snapshot(s) to the vote agent via Electronic Data Interchanges.

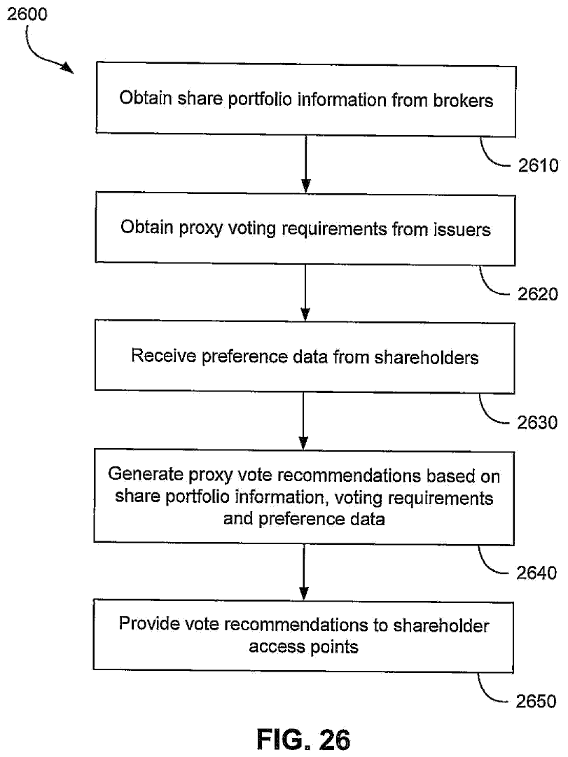

FIG. 26 is a flowchart illustrating method 2600 for providing proxy vote recommendations to a shareholder access point according to an embodiment of the present disclosure. Method 2600 may be performed by a proxy vote server, such as main server 150 shown in FIG. 1 and/or a data communications protocol platform module, such as module 214 shown in FIG. 2. The method begins at step 2610 where the proxy vote server obtains share portfolio information for a plurality of shareholders from a broker. The broker may store information relating to the shareholders it represents in a database. In some implementations, the broker may not make available the personally identifiable information (PII) of its shareholders. The proxy vote server also obtains proxy voting requirements from share issuers (step 2620). Such proxy voting requirements as stipulated by 14a-8 shareholder proposals, schedule 13D, and the U.S. Securities and Exchange Commission. Further, in step 2630, the proxy vote server receives vote preference data from the shareholder who subscribe to the voter proxy service. Such vote preference data may include the propensity a shareholder has towards a particular event affecting a share issuer, for example.

Next, in step 2640, the proxy vote server generates proxy vote recommendations for each of the shareholders based on the share portfolio information, the voting requirements, and the shareholder preference data. Such proxy vote recommendation may be generated using an aggregation of the share portfolio information, the voting requirements, and the shareholder preference data. In some implementations, a Q&A platform within the proxy vote server may generate questions to shareholders via API in order to track the actual preferences of a shareholder. Such questions are sent to the access points of each shareholder (an interactive graphical user device such as a smartphone running a proxy vote recommendations application, for example) via API in real time. An example of such an interactive graphical user device is show as GUI 145 in FIG. 1. In some implementations, the responses from all the shareholders for a specific share issuer are consolidated and provided as feedback to the proxy server which then tailors the questions presented to the shareholder so that the resulting generated proxy vote recommendations are a closer representation of the shareholder's actual vote.

In step 2650, the proxy vote recommendations are provided to the respective shareholders via the shareholder access points. In some implementations, if a shareholder has permitted automated proxy voting, the proxy server provides the generated proxy vote recommendation for that shareholder directly to the share issuer as a proxy vote. In other implementations, the proxy vote recommendation allows the shareholder to vote using the interactive graphical interface of the shareholder access point either with certain proxy vote recommendations, or without using any proxy vote recommendations.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

Other objects, advantages and embodiments of the various aspects of the present invention will be apparent to those who are skilled in the field of the invention and are within the scope of the description and the accompanying drawings. For example, but without limitation, structural or functional elements might be rearranged consistent with the present invention. Similarly, principles according to the present invention could be applied to other examples, which, even if not specifically described here in detail, would nevertheless be within the scope of the present invention.

1. A method performed by a server, the method comprising:
obtaining share portfolio information for one or more shareholders from a broker database;
obtaining proxy voting requirements from at least one share issuer;
receiving shareholder preference data from the one or more shareholders;
generating proxy vote recommendations based on the share portfolio information, proxy voting requirements and the shareholder preference data; and
providing the proxy vote recommendations to an interactive graphical interface of a shareholder access point of each of the one or more shareholders using Application Programming Interface (API).

2. The method of claim 1, further comprising:
providing proxy votes directly to the at least one share issuer on behalf of the one or more shareholders based on the proxy vote recommendations using API.

3. The method of claim 1, further comprising:
enabling each shareholder to proxy vote using the interactive graphical interface on their respective shareholder access point either (i) without the proxy vote recommendations, or (ii) with certain proxy vote recommendations.

4. The method of claim 1, further comprising:
consolidating the proxy votes on the server based on aggregated proxy votes received from the one or more shareholders via API.

5. The method of claim 1, further comprising:
providing polls to the one or more shareholders via API to obtain shareholder opinions.

6. The method of claim 5, further comprising:
using the poll data to generate the proxy vote recommendations.

7. The method of claim 1, wherein the share portfolio information does not contain personally identifiable information of the one or more shareholders.

8. The method of claim 1, wherein the proxy voting requirements include adherence to at least one of 14a-8 shareholder proposal requirements, schedule 13D requirements, and U.S. Securities and Exchange Commission requirements (Staff Legal Bulletin No. 20 (IM/CF)).

9. The method of claim 1, wherein the shareholder preference data comprises an aggregation of data from a population of shareholders.

10. The method of claim 1, wherein the shareholder access point comprises a mobile device.

11. A computer program product comprising computer-readable code embodied in a non-transitory computer-readable storage medium which, when executed by one or more processors of a computing device, causes the computing device to perform a method comprising:
obtaining share portfolio information for one or more shareholders from a broker database;
obtaining proxy voting requirements from at least one share issuer;
receiving shareholder preference data from the one or more shareholders;
generating proxy vote recommendations based on the share portfolio information, proxy voting requirements and the shareholder preference data; and
providing the proxy vote recommendations to an interactive graphical interface of a shareholder access point of each of the one or more shareholders using Application Programming Interface (API).

12. The computer program product of claim 11, wherein the method further comprises:
providing proxy votes directly to the at least one share issuer on behalf of at least a portion of the one or more shareholders based on the proxy vote recommendations using API.

13. The computer program product of claim 11, wherein the method further comprises:
enabling each shareholder to proxy vote using the interactive graphical interface on their respective shareholder access point either (i) without the proxy vote recommendations, or (ii) with certain proxy vote recommendations.

14. The computer program product of claim 11, wherein the method further comprises:
consolidating the proxy votes on the server based on aggregated proxy votes received from the one or more shareholders via API.

15. The computer program product of claim 11, wherein the method further comprises:
providing polls to the one or more shareholders via API to obtain shareholder opinions.

16. The computer program product of claim 15, wherein the method further comprises:
using the poll data to generate the proxy vote recommendations.

17. The computer program product of claim 11, wherein the share portfolio information does not contain personally identifiable information of the one or more shareholders.

18. The computer program product of claim 11, wherein the proxy voting requirements include adherence to at least one of 14a-8 shareholder proposal requirements, schedule 13D requirements, and U.S. Securities and Exchange Commission requirements (Staff Legal Bulletin No. 20 (IM/CF)).

19. The computer program product of claim 11, wherein the shareholder preference data comprises an aggregation of data from a population of shareholders.

20. The computer program product of claim 11, wherein the shareholder access point comprises a mobile device.
